(19) United States
(12) Patent Application Publication
(10) Pub. No.: US 2024/0340054 A1
(43) Pub. Date: Oct. 10, 2024

(54) MULTIPLE CSI REPORTS

(71) Applicant: Samsung Electronics Co., Ltd., Suwon-si (KR)

(72) Inventors: Jeongho Jeon, San Jose, CA (US); Aristides Papasakellariou, Houston, TX (US)

(21) Appl. No.: 18/611,608

(22) Filed: Mar. 20, 2024

Related U.S. Application Data
(60) Provisional application No. 63/457,268, filed on Apr. 5, 2023.
(60) Provisional application No. 63/457,276, filed on Apr. 5, 2023.
(60) Provisional application No. 63/464,437, filed on May 5, 2023.

(51) Int. Cl. H04B 7/06; H04L 5/00; H04W 24/10

(52) U.S. Cl. CPC H04B 7/0626; H04L 5/0053; H04W 24/10

(57) ABSTRACT

Apparatuses and methods for multiple channel state information (CSI) reports. A method for a user equipment (UE) to report CSI including one or more sub-reports includes receiving first information related to reception of one or more non-zero power CSI reference signals (NZP CSI-RSs) on a cell, second information related to a first number of sub-configurations corresponding to respective CSI sub-reports, third information indicating a second number of sub-configurations from the first number of sub-configurations corresponding to a second number of CSI sub-reports, respectively, fourth information related to an uplink channel for transmitting the CSI report, and the one or more NZP CSI-RSs based on the first information. The method further includes determining the second number of CSI sub-reports based on the second and third information and the one or more NZP CSI-RSs and transmitting the uplink channel with the CSI report including the second number of CSI sub-reports.

### CROSS-REFERENCE TO RELATED AND CLAIM OF PRIORITY

The present application claims priority under 35 U.S.C. § 119 (e) to U.S. Provisional Patent Application No. 63/457,276 filed on Apr. 5, 2023; U.S. Provisional Patent Application No. 63/457,268 filed on Apr. 5, 2023; and U.S. Provisional Patent Application No. 63/464,437 filed on May 5, 2023, which are hereby incorporated by reference in their entirety.

### TECHNICAL FIELD

The present disclosure relates generally to wireless communication systems and, more specifically, the present disclosure is related to apparatuses and methods for multiple channel state information (CSI) reports.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to multiple CSI reports.

In one embodiment, a method for a user equipment (UE) to report channel state information (CSI) including one or more sub-reports is provided. The method includes receiving first information related to reception of one or more non-zero power CSI reference signals (NZP CSI-RSs) on a cell, second information related to a first number of sub-configurations corresponding to respective CSI sub-reports, third information related to indicating a second number of sub-configurations from the first number of sub-configurations, the second number of sub-configurations corresponding to a second number of CSI sub-reports, respectively, fourth information related to a physical uplink control channel (PUCCH) or a physical uplink shared channel (PUSCH) for transmitting the CSI report, and the one or more NZP CSI-RSs based on the first information. Each sub-configuration corresponds to an adaptation of parameters in one or more of a spatial or power domain associated with receptions of channels or signals. The method further includes determining the second number of CSI sub-reports based on the second information, the third information, and the reception of the one or more NZP CSI-RSs and transmitting the PUSCH with the CSI report including the second number of CSI sub-reports.

In another embodiment, a user equipment (UE) is provided. The UE includes a transceiver configured to receive first information related to reception of one or more NZP CSI-RSs on a cell, second information related to a first number of sub-configurations corresponding to respective CSI sub-reports, third information related to indicating a second number of sub-configurations from the first number of sub-configurations, the second number of sub-configurations corresponding to a second number of CSI sub-reports, respectively, fourth information related to a PUCCH or a PUSCH for transmitting the CSI report, and the one or more NZP CSI-RSs based on the first information. Each sub-configuration corresponds to an adaptation of parameters in one or more of a spatial or power domain associated with receptions of channels or signals. The UE further includes a processor operably coupled to the transceiver. The processor is configured to determine the second number of CSI sub-reports based on the second information, the third information, and the reception of the one or more NZP CSI-RSs. The transceiver is further configured to transmit the PUSCH with the CSI report including the second number of CSI sub-reports.

In yet another embodiment, a base station (BS) is provided. The BS includes a processor and a transceiver operably coupled to the processor. The transceiver is configured to transmit first information related to transmission of one or more NZP CSI-RSs on a cell, second information related to a first number of sub-configurations corresponding to respective CSI sub-reports, third information related to indicating a second number of sub-configurations from the first number of sub-configurations, the second number of sub-configurations corresponding to a second number of CSI sub-reports, respectively, fourth information related to a PUCCH or a PUSCH for the CSI report, and the one or more NZP CSI-RSs based on the first information. Each sub-configuration corresponds to an adaptation of parameters in one or more of a spatial or power domain associated with transmissions of channels or signals. The transceiver is further configured to receive the PUSCH with the CSI report including the second number of CSI sub-reports.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIGS. 6A and 6B illustrate an example of a transmitter and receiver structures using orthogonal frequency division multiplexing (OFDM) according to embodiments of the present disclosure;

FIGS. 7A and 7B illustrate a flow diagram of an encoding and decoding processes for downlink control information (DCI) according to embodiments of the present disclosure;

FIGS. 8A and 8B illustrate timelines for example cell discontinued transmissions (DTX) and discontinued receptions (DRX) according to embodiments of the present disclosure;

FIG. 9 illustrates diagrams of example spatial domain adaptations according to embodiments of the present disclosure;

FIG. 10 illustrates a flowchart of an example UE procedure for measuring and reporting multiple CSI(s) according to embodiments of the present disclosure;

FIG. 11 illustrates a diagram of an example 32 port channel state information reference signal (CSI-RS) according to embodiments of the present disclosure;

FIG. 12 illustrates a diagram of an example mapping of a 32 port CSI-RS resource to a 4-by-4 cross polarized antenna system and code-division multiplexing (CDM) group-level sub-configurations according to embodiments of the present disclosure;

FIG. 13 illustrates a diagram of an example mapping of a 32 port CSI-RS resource to an 8-by-2 cross polarized antenna system and CDM group-level sub-configurations according to embodiments of the present disclosure;

FIG. 14 illustrates a diagram of an example mapping of a 32 port CSI-RS resource to a 4-by-4 cross polarized antenna system and antenna port level sub-configurations according to embodiments of the present disclosure;

FIG. 15 illustrates a diagram of an example precoding matrix indicator (PMI) compression according to embodiments of the present disclosure;

FIG. 16 illustrates a flowchart of an example UE procedure for measuring and reporting CSI according to embodiments of the present disclosure; and

FIG. 17 illustrates a diagram of UE sub-grouping for triggering CSI measurement and report according to embodiments of the present disclosure.

### DETAILED DESCRIPTION

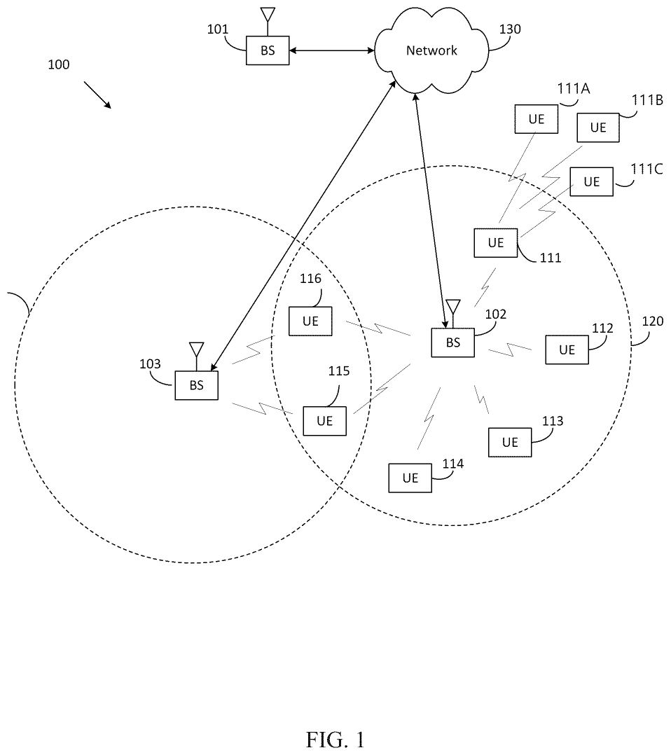

FIGS. 1-17, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v17.4.0, “NR; Physical channels and modulation;” [2] 3GPP TS 38.212 v17.4.0, “NR; Multiplexing and channel coding;” [3] 3GPP TS 38.213 v17.4.0, “NR; Physical layer procedures for control;” [4] 3GPP TS 38.214 v17.4.0, “NR; Physical layer procedures for data;” [5] 3GPP TS 38.215 v17.4.0, “NR; Physical layer measurements;” and [6] 3GPP TS 38.321 v17.3.0, “NR; Medium Access Control (MAC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally regarded as a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for determining multiple CSI reports. In certain embodiments, one or more of the BSs 101-103 include circuitry, programing, or a combination thereof to support determination of multiple CSI reports.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

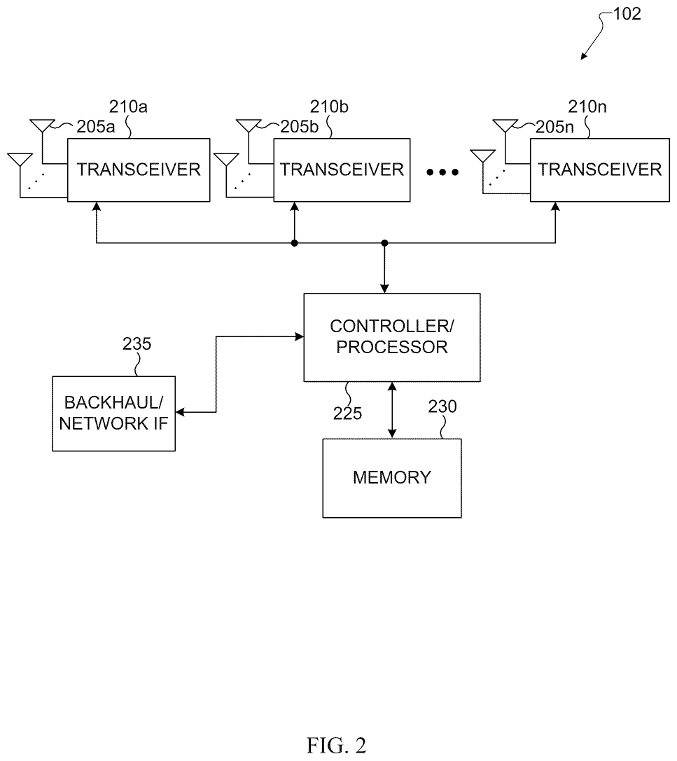

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for determining multiple CSI reports. Any of a wide variety of other functions could be supported in the gNB 102 by the controller/processor 225.

The controller/processor 225 is also capable of executing programs and other processes resident in the memory 230, such as processes for supporting multiple CSI reports. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

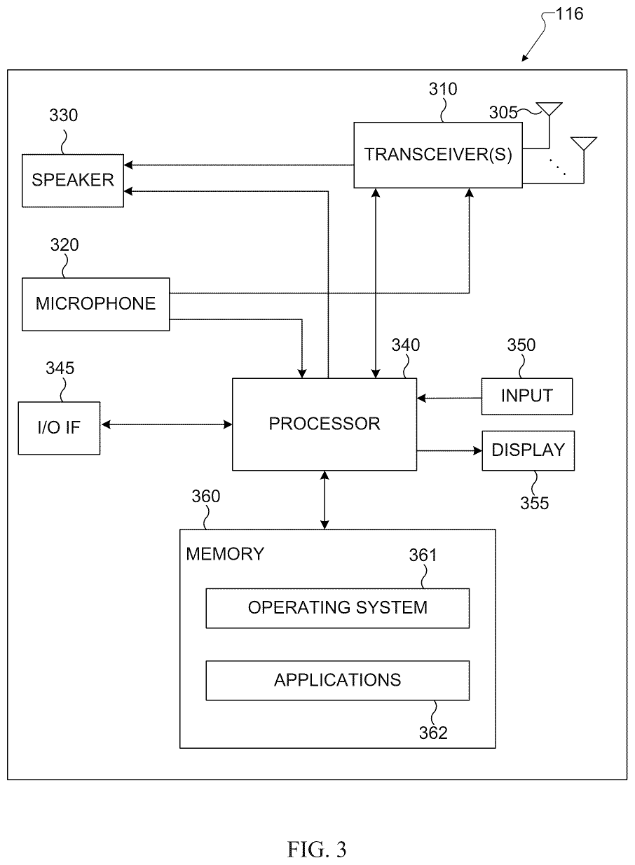

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for determining multiple CSI reports as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

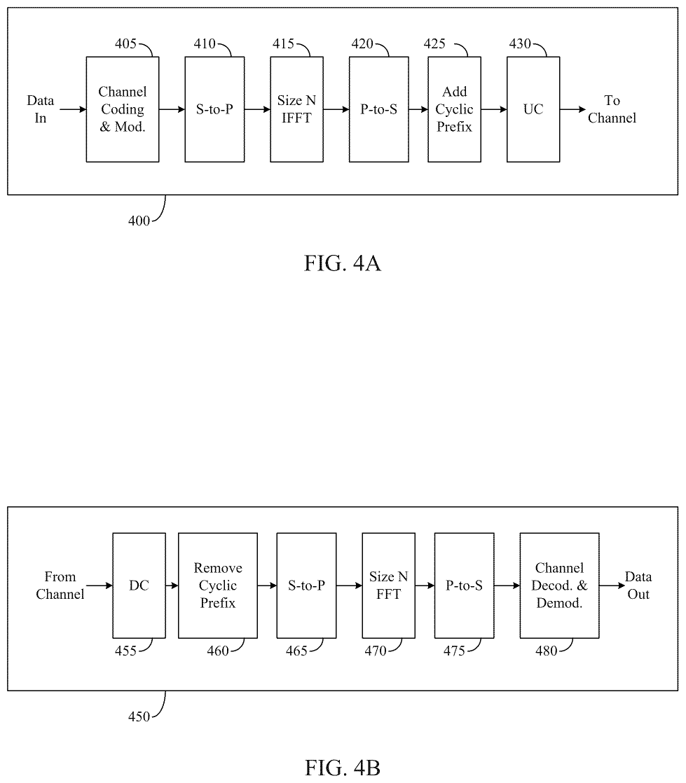

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured for transmission of multiple CSI reports as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In embodiments of the present disclosure, a beam is determined by either a transmission configuration indicator (TCI) state that establishes a quasi-colocation (QCL) relationship between a source reference signal (RS) (e.g., single sideband (SSB) and/or Channel State Information Reference Signal (CSI-RS)) and a target RS or a spatial relation information that establishes an association to a source RS, such as SSB or CSI-RS or sounding RS (SRS). In either case, the ID of the source reference signal identifies the beam. The TCI state and/or the spatial relation reference RS can determine a spatial RX filter for reception of downlink channels at the UE 116, or a spatial TX filter for transmission of uplink channels from the UE 116.

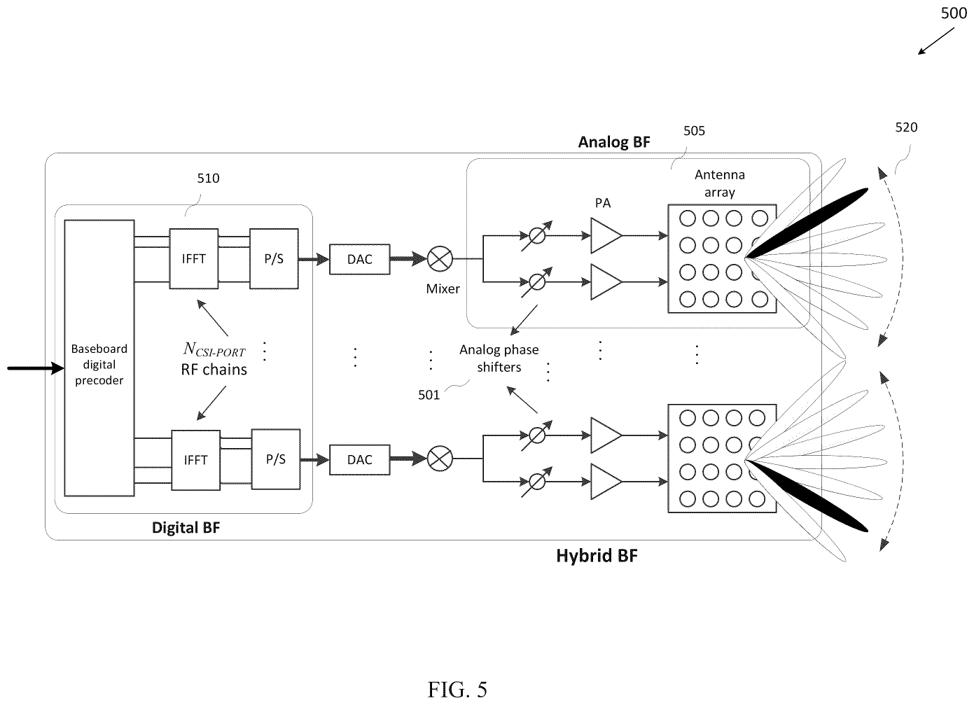

FIG. 5 illustrates an example of a transmitter structure 500 for beamforming according to embodiments of the present disclosure. In certain embodiments, one or more of gNB 102 or UE 116 includes the transmitter structure 500. For example, one or more of antennas 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI-RS antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports NCSI-PORT. A digital beamforming unit 510 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 500 for beamforming is for illustration only and other embodiments can be used without departing from the scope of the present disclosure.

In the following, an italicized name for a parameter implies that the parameter is provided by higher layers.

DL transmissions or UL transmissions can be based on an OFDM waveform including a variant using DFT precoding that is known as DFT-spread-OFDM that is typically applicable to UL transmissions.

In the following, subframe (SF) refers to a transmission time unit for the LTE RAT and slot refers to a transmission time unit for an NR RAT. For example, the slot duration can be a sub-multiple of the SF duration. NR can use a different DL or UL slot structure than an LTE SF structure. Differences can include a structure for transmitting physical downlink control channels (PDCCHs), locations and structure of demodulation reference signals (DM-RS), transmission duration, and so on. Further, eNB refers to a base station serving UEs operating with LTE RAT and gNB refers to a base station serving UEs operating with NR RAT. Exemplary embodiments evaluate a same numerology, that includes a sub-carrier spacing (SCS) configuration and a cyclic prefix (CP) length for an OFDM symbol, for transmission with LTE RAT and with NR RAT. In such case, OFDM symbols for the LTE RAT as same as for the NR RAT, a subframe is same as a slot and, for brevity, the term slot is subsequently used in the remaining of the disclosure.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration μ as 2^{μ}. 15 kHz. A unit of one sub-carrier over one symbol is referred to as resource element (RE). A unit of one RB over one symbol is referred to as physical RB (PRB).

DL signaling include physical downlink shared channels (PDSCHs) conveying information content, PDCCHs conveying DL control information (DCI), and reference signals (RS). A PDCCH can be transmitted over a variable number of slot symbols including one slot symbol and over a number of control channel elements (CCEs) from a predetermined set of numbers of CCEs referred to as CCE aggregation level within a control resource set (CORESET) as described in 3GPP TS 36.211 v17.4.0, “NR; Physical channels and modulation”, and 3GPP TS 38.213 v17.4.0 “NR; Physical Layer procedures for control”.

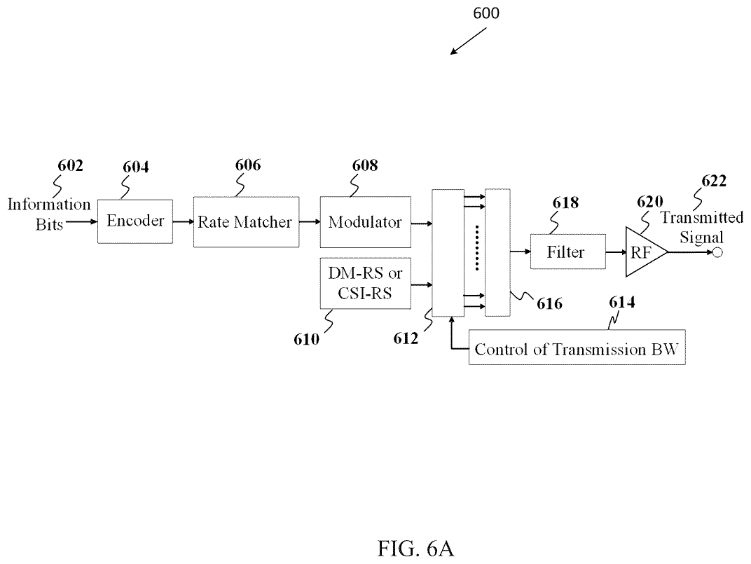

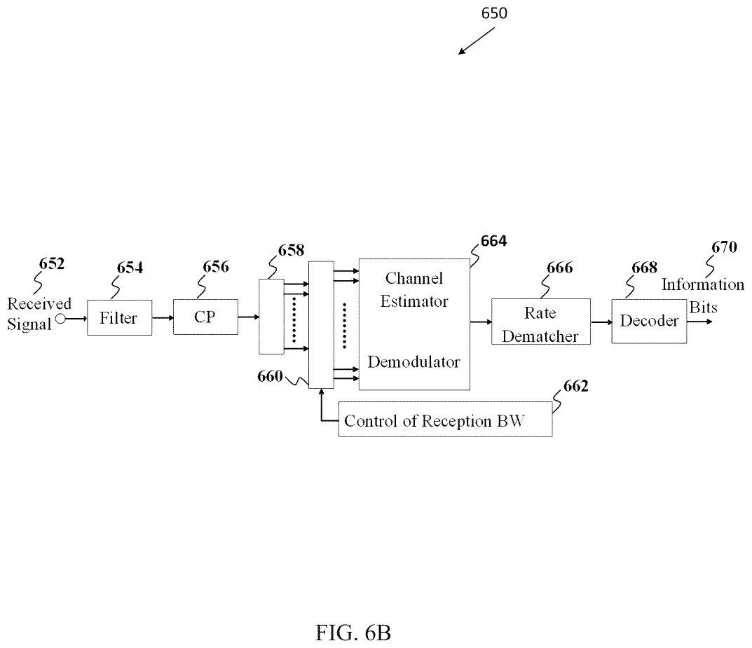

FIGS. 6A and 6B illustrate an example of transmitter and receiver structures 600 and 650, respectively, using OFDM according to embodiments of the present disclosure. For example, a transmit structure 600 may be described as being implemented in a gNB (such as gNB 102), while a receive structure 650 may be described as being implemented in a UE (such as UE 116). This example is for illustration only and other embodiments can be used without departing from the scope of the present disclosure.

Information bits, such as DCI bits or data bits 602, are encoded by encoder 604, rate matched to assigned time/frequency resources by rate matcher 606 and modulated by modulator 608. Subsequently, modulated encoded symbols and DM-RS or CSI-RS 610 are mapped to REs 612 by RE mapping unit 614, an inverse fast Fourier transform (IFFT) is performed by filter 616, a cyclic prefix (CP) is added by CP insertion unit 618, and a resulting signal is filtered by filter 620 and transmitted by a radio frequency (RF) unit 622.

A received signal 652 is filtered by filter 654, a CP removal unit removes a CP 656, a filter 658 applies a fast Fourier transform (FFT), RE de-mapping unit 660 de-maps REs selected by BW selector unit 662, received symbols are demodulated by a channel estimator and a demodulator unit 664, a rate de-matcher 666 restores a rate matching, and a decoder 668 decodes the resulting bits to provide information bits 670.

DCI can serve several purposes. A DCI format includes a number of fields, or information elements (IEs), and is typically used for scheduling a PDSCH (DL DCI format) or a physical uplink shared channel (PUSCH) (UL DCI format) transmission. A DCI format includes cyclic redundancy check (CRC) bits in order for a UE to confirm a correct detection. A DCI format type is identified by a radio network temporary identifier (RNTI) that scrambles the CRC bits. For a DCI format scheduling a PDSCH or a PUSCH for a single UE with radio resource control (RRC) connection to a gNB, the RNTI is a cell RNTI (C-RNTI) or another RNTI type such as a modulation and coding scheme (MCS)-C-RNTI. For a DCI format scheduling a PDSCH conveying system information (SI) to a group of UEs, the RNTI is a SI-RNTI. For a DCI format scheduling a PDSCH providing a response to a random access (RA) from a group of UEs, the RNTI is a RA-RNTI. For a DCI format scheduling a PDSCH providing contention resolution in Msg4 of a RA process, the RNTI is a temporary C-RNTI (TC-RNTI). For a DCI format scheduling a PDSCH paging a group of UEs, the RNTI is a paging RNTI (P-RNTI). For a DCI format providing transmission power control (TPC) commands to a group of UEs, the RNTI is a TPC-RNTI, and so on. Each RNTI type is configured to a UE through higher layer signaling. A UE typically decodes at multiple candidate locations for potential PDCCH receptions as determined by an associated search space set.

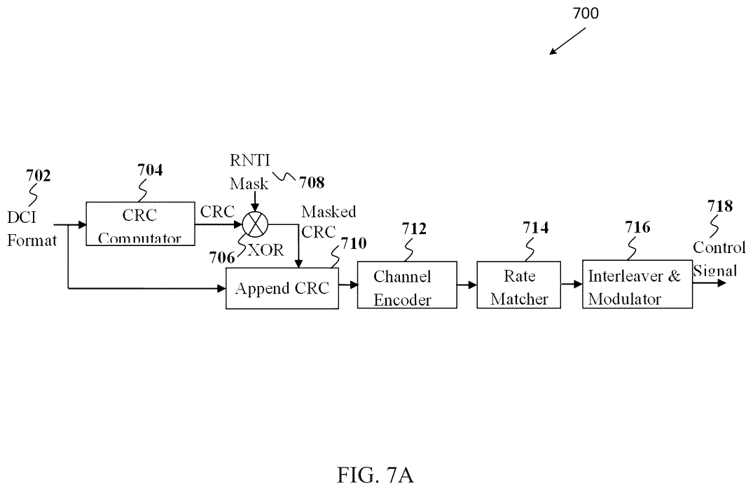

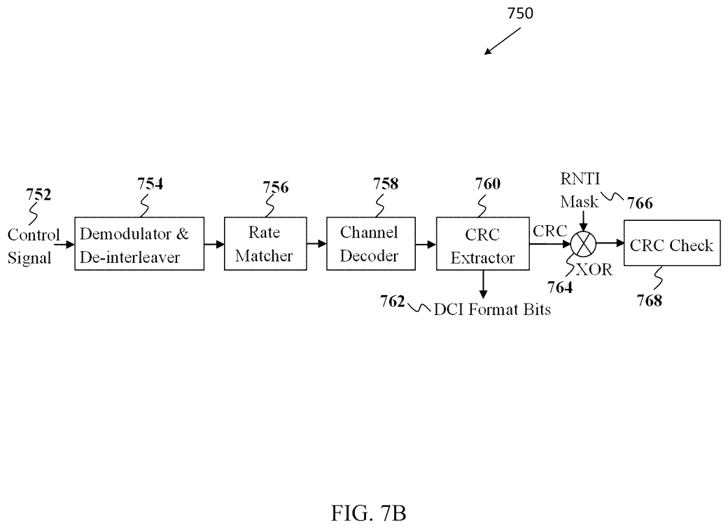

FIGS. 7A and 7B illustrate an example of an encoding and decoding processes 700 and 750, respectively, for DCI according to embodiments of the present disclosure. For example, encoding process 700 may be implemented by a BS 102 while decoding process 750 may be implemented by any of the UEs 111-116 of FIG. 1. This example is for illustration only and other embodiments can be used without departing from the scope of the present disclosure.

A gNB separately encodes and transmits each DCI format in a respective PDCCH. When applicable, a RNTI for a UE that a DCI format is intended for masks a CRC of the DCI format codeword in order to enable the UE to identify the DCI format. For example, the CRC can include 24 bits and the RNTI can include 16 bits or 24 bits. The CRC of (non-coded) DCI format bits 702 is determined using a CRC computation unit 704, and the CRC is masked using an exclusive OR (XOR) operation unit 706 between CRC bits and RNTI bits 708. The XOR operation is defined as XOR (0,0)=0, XOR (0,1)=1, XOR (1,0)=1, XOR (1,1)=0. The masked CRC bits are appended to DCI format information bits using a CRC append unit 710. An encoder 712 performs channel coding, such as polar coding, followed by rate matching to allocated resources by rate matcher 714. Interleaving and modulation units 716 apply interleaving and modulation, such as QPSK, and the output control signal 718 is transmitted.

A received control signal 752 is demodulated and de-interleaved by a demodulator and a de-interleaver 754. A rate matching applied at a gNB transmitter is restored by rate matcher 756, and resulting bits are decoded by decoder 758. After decoding, a CRC extractor 760 extracts CRC bits and provides DCI format information bits 762. The DCI format information bits are de-masked 764 by an XOR operation with a RNTI 766 (when applicable) and a CRC check is performed by unit 768. When the CRC check succeeds (check-sum is zero), the DCI format information bits are regarded to be valid. When the CRC check does not succeed, the DCI format information bits are regarded to be invalid.

For each DL bandwidth part (BWP) indicated to a UE in a serving cell, the UE can be provided by higher layer signaling with P≤3 control resource sets (CORESETs). For each CORESET, the UE is provided a CORESET index p, 0≤p<12, a DM-RS scrambling sequence initialization value, a precoder granularity for a number of resource element groups (REGs) in the frequency domain where the UE can assume use of a same DM-RS precoder, a number of consecutive symbols for the CORESET, a set of resource blocks (RBs) for the CORESET, CCE-to-resource element groups (REG) mapping parameters, an antenna port quasi co-location, from a set of antenna port quasi co-locations, indicating quasi co-location information of the DM-RS antenna port for PDCCH reception in a respective CORESET, and an indication for a presence or absence of a transmission configuration indication (TCI) field for DCI format 1_1 transmitted by a PDCCH in CORESET p.

For each DL BWP configured to a UE in a serving cell, the UE is provided by higher layers with S≤10 search space sets. For each search space set from the S search space sets, the UE is provided a search space set index s, 0≤s<40, an association between the search space set s and a CORESET p, a PDCCH monitoring periodicity of kₛ slots and a PDCCH monitoring offset of oₛ slots, a PDCCH monitoring pattern within a slot indicating first symbol(s) of the CORESET within a slot for PDCCH monitoring, a duration of Tₛ<kₛ slots indicating a number of slots that the search space set s exists, a number of PDCCH candidates Mₛ^{(L)} per CCE aggregation level L, and an indication that search space set s is either a common search space (CSS) set or a UE-specific search space (USS) set. When search space set s is a CSS set, the UE monitors PDCCH for detection of DCI format 2_x, where x ranges from 0 to 7 as described in TS 38.212 [REF2] v17.4.0, or for DCI formats associated with scheduling broadcast/multicast PDSCH receptions, and possibly for DCI format 0_0 and DCI format 1_0.

A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in a slot with number n_{s,f}^{μ} in a frame with number n_{f} if (n_{f}·Nₛₗₒₜ^{frame,μ}+n_{s,f}^{μ}−oₛ) mod kₛ=0. The UE monitors PDCCH candidates for search space set s for Tₛ consecutive slots, starting from slot n_{s,f}^{μ}, and does not monitor PDCCH candidates for search space set s for the next kₛ-Tₛ consecutive slots. The UE determines CCEs for monitoring PDCCH according to a search space set based on a search space equation as described in TS 38.213 [REF3] v17.4.0.

A UE expects to monitor PDCCH candidates for up to 4 sizes of DCI formats that include up to 3 sizes of DCI formats with CRC scrambled by C-RNTI per serving cell. The UE counts a number of sizes for DCI formats per serving/scheduled cell based on a number of PDCCH candidates in respective search space sets for the corresponding active DL BWP. In the following, for brevity, that constraint for the number of DCI format sizes will be referred to as DCI size limit. When the DCI size limit would be exceeded for a UE based on a configuration of DCI formats that the UE monitors PDCCH, the UE aligns the size of some DCI formats, as described in TS 38.212 [REF2] v17.4.0, so that the DCI size limit would not be exceeded.

For each scheduled cell, the UE is not required to monitor on the active DL BWP with SCS configuration μ of the scheduling cell more than min (M_{PDCCH}^{max,slot,μ}, M_{PDCCH}^{total,slot,μ}) PDCCH candidates or more than min (C_{PDCCH}^{max,slot,μ}, C_{PDCCH}^{total,slot,μ}) non-overlapped CCEs per slot, wherein, M_{PDCCH}^{max,slot,μ} and C_{PDCCH}^{max,slot,μ} are respectively a maximum number of PDCCH candidates and non-overlapping CCEs for a scheduled cell and M_{PDCCH}^{total,slot,μ} and C_{PDCCH}^{total,slot,μ} are respectively a total number of PDCCH candidates and non-overlapping CCEs for a scheduling cell, as described in TS 38.213 [REF3] v17.4.0.

A UE does not expect to be configured CSS sets, other than CSS sets for multicast PDSCH scheduling, that result to corresponding total, or per scheduled cell, numbers of monitored PDCCH candidates and non-overlapped CCEs per slot on the primary cell that exceed the corresponding maximum numbers per slot. For USS sets or for CSS sets associated with multicast PDSCH scheduling, when a number of PDCCH candidates or non-overlapping CCEs in a slot would exceed the aforementioned limits/maximum per slot for scheduling on the primary cell, the UE selects the USS sets or the CSS sets to monitor corresponding PDCCH in an ascending order of a corresponding search space set index until and an index of a search space set for which PDCCH monitoring would result to exceeding the maximum number of PDCCH candidates or non-overlapping CCEs per slot for scheduling on the PCell as described in TS 38.213 [REF3] v17.4.0.

For same cell scheduling or for cross-carrier scheduling where a scheduling cell and scheduled cells have DL BWPs with same SCS configuration u, a UE does not expect a number of PDCCH candidates, and a number of corresponding non-overlapped CCEs per slot on a secondary cell to be larger than the corresponding numbers that the UE is capable of monitoring on the secondary cell per slot. For cross-carrier scheduling, the number of PDCCH candidates for monitoring and the number of non-overlapped CCEs per slot are separately counted for each scheduled cell.

A UE can be configured for operation with carrier aggregation (CA) for PDSCH receptions over multiple cells (DL CA) or for PUSCH transmissions over multiple cells (UL CA). The UE can also be configured multiple transmission-reception points (TRPs) per cell via indication (or absence of indication) of a coresetPoolIndex for CORESETs where the UE receives PDCCH/PDSCH from a corresponding TRP as described in TS 38.213 v17.4.0 and TS 38.214 [REF4] v17.4.0.

MIMO technologies have a key role in boosting system throughput both in NR and LTE and such a role will continue and further expand in the future generations of wireless technologies.

For MIMO operation, an antenna port is defined such that a channel over which a symbol on the antenna port is conveyed can be inferred from the channel over which another symbol on the same antenna port is conveyed. There is not necessarily a one to one correspondence between an antenna port and an antenna element, and a plurality of antenna elements can be mapped onto one antenna port.

To enable digital precoding, it is important to provide an efficient design of CSI-RS in order to address various operating conditions while maintaining a low overhead for CSI-RS transmissions. For that reason, three types of CSI reporting mechanism corresponding to three types of CSI-RS measurement behavior are supported in Rel. 13 LTE: 1) ‘CLASS A’ CSI reporting that corresponds to non-precoded CSI-RS, 2) ‘CLASS B’ CSI reporting with K=1 CSI-RS resource that corresponds to UE-specific beamformed CSI-RS, and 3) ‘CLASS B’ reporting with K>1 CSI-RS resources that corresponds to cell-specific beamformed CSI-RS. For non-precoded (NP) CSI-RS, a cell-specific one-to-one mapping between CSI-RS port and transmission rate unit (TXRU) is utilized. Here, different CSI-RS ports have the same wide beam width and direction and hence generally cell-wide coverage. For beamformed CSI-RS, beamforming operation, either cell-specific or UE-specific, is applied on a non-zero-power (NZP) CSI-RS resource including multiple ports. Here, at least at a given time/frequency resources, CSI-RS ports have narrow beam widths, and hence do not provide cell-wide coverage, and (at least from the eNB perspective) at least some CSI-RS port-resource combinations have different beam directions. The basic principle remains same in NR.

In scenarios where a gNB can measure long-term DL channel statistics for a UE through receptions of signals from the UE, such as SRS or DM-RS, UE-specific beamformed CSI-RS can be readily used. This is typically feasible when UL-DL duplex distance is sufficiently small. When that condition does not hold, UE feedback is necessary for the gNB to obtain an estimate of long-term DL channel statistics (or any of its representation thereof). To facilitate such a procedure, a first beamformed CSI-RS transmitted with periodicity T1 (msec) and a second NP CSI-RS transmitted with periodicity T2 (msec), where T1≤T2. This approach is referred to as hybrid CSI-RS. The implementation of hybrid CSI-RS depends on the definition of CSI processes and NZP CSI-RS resources.

One important component of a MIMO transmission scheme is the accurate CSI acquisition at the gNB (or TRP). For multi-user (MU)-MIMO, in particular, availability of accurate CSI is necessary in order to guarantee robust MU performance and avoid interference among transmissions to different UEs. For time division duplexing (TDD) systems, CSI can be acquired using SRS transmissions from UEs by relying on DL/UL channel reciprocity. For frequency division duplexing (FDD) systems, a gNB can acquire CSI by transmitting CSI-RS and obtaining corresponding CSI reports from UEs. A CSI reporting framework can be ‘implicit’ in the form of channel quality indicator (CQI)/precoding matrix indicator (PMI)/rank indicator (RI), and possibly CSI-RS resource indicator (CRI), as derived from a codebook assuming SU transmission from eNB. Because of the inherent SU assumption while deriving CSI, implicit CSI feedback is inadequate for MU transmissions. For MU-centric operation, a high-resolution Type-II codebook, in addition to low resolution Type-I codebook, can be used.

A serving gNB (such as the BS 102) can configure Type-I and Type-II CSI codebooks to a UE using higher layer signalling to provide a CodebookConfig IE, as described in TS 38.331 [REF5] v17.4.0, that includes the following parameters.
codebookType includes type1, type2 and possibly sub-types such as typeI-SinglePanel, typeI-MultiPanel, typeII, and typeII-PortSelection, and corresponding parameters for each type.
n1-n2 configures a number of antenna ports in first (n1) and second (n2) dimension and codebook subset restriction for typeI-SinglePanel.
ng-n1-n2 configures a number of antenna panels (ng), a number of antenna ports in first (n1) and second (n2) dimension assuming that the antenna structure is identical for the configured number of panels, and a codebook subset restriction for Type I Multi-panel codebook.
n1-n2-codebookSubsetRestriction configures a number of antenna ports in first (n1) and second (n2) dimension and a codebook subset restriction for typeII.
CodebookConfig-r17 includes type1-SinglePanel1-r17 and type1-SinglePanel2-r17 for type I to enable configuration of different antenna structures for two TRPs.

The IE RS-ResourceMapping indicates a resource element mapping for a CSI-RS resource in the time and frequency domains. The container of the IE includes elements for configuration of time and frequency domain resources such as by firstOFDMSymbolIn Time Domain, firstOFDMSymbolInTimeDomain2, and frequencyDomainAllocation, the CSI-RS density by density, the number of ports by nrofPorts, and others. The IE CSI-RS-ResourceMapping comprises the NZP-CSI-RS-Resource and ZP-CSI-RS-Resource configurations that are included in the CSI-ResourceConfig. The IE CSI-ResourceConfig defines a group of one or more NZP-CSI-RS-ResourceSet, CSI-IM-ResourceSet and/or CSI-SSB-ResourceSet.

The IE CSI-ReportConfig is used to indicate to a UE parameters for providing a periodic or semi-persistent CSI report via physical uplink control channel (PUCCH) transmissions on the cell where CSI-ReportConfig is included, or to indicate parameters for providing a semi-persistent or aperiodic CSI report on a PUSCH as triggered by a DCI that the UE receives. The CSI-ReportConfig is set for certain CSI-ResourceConfigId for channel/interference measurements. The aforementioned CodebookConfig is also part of CSI-ReportConfig.

For aperiodic CSI, both aperiodic CSI reporting and aperiodic CSI-RS transmission are triggered using a ‘CSI Request’ field within a DCI format scheduling a PUSCH transmission, such as DCI format 0_1. The ‘CSI Request’ field indicates a ‘Trigger State’ that points to a certain CSI-ReportConfigId and resourcesForChannel, e.g., NZP-CSI-RS-Resource Set. The ‘CSI Request’ field can have up to 6 bits and can indicate up to 64 ‘Trigger States’. If a UE is configured with more than 64 ‘Trigger States’, a ‘Aperiodic CSI Trigger State Subselection’ MAC control element (CE) identifies a subset of Trigger States that are indicated by DCI.

For semi-persistent CSI (SP CSI-RS) on PUCCH, the semi-persistent CSI-RS resource is triggered by a “SP CSI-RS/CSI interference measurement (CSI-IM) Resource Set Activation/Deactivation” MAC CE that includes a SP CSI-RS resource set ID indicating an index of NZP-CSI-RS-ResourceSet containing Semi Persistent NZP CSI-RS resources indicating the Semi Persistent NZP CSI-RS resource set that is to be activated or deactivated. Semi-persistent CSI reporting on PUCCH is triggered using the “SP CSI reporting on PUCCH Activation/Deactivation” MAC CE. The field Sᵢ in the MAC CE indicates the activation/deactivation status of the Semi-Persistent CSI report configuration within csi-ReportConfigToAddModList. So refers to the report configuration that includes PUCCH resources for semi-persistent CSI reporting in the indicated BWP and has the lowest CSI-ReportConfigId within the list with type set to semiPersistentOnPUCCH. S₁ refers to the report configuration that includes PUCCH resources for semi-persistent CSI reporting in the indicated BWP and has the second lowest CSI-ReportConfigId, and so on.

For semi-persistent CSI reporting on PUSCH, a CSI report is triggered using a ‘CSI Request’ field in a DCI format 0_1 with CRC scrambled by a SP-CSI-RNTI. The operating details are similar to those for an aperiodic CSI report.

For periodic CSI reporting, both reporting and periodic CSI-RS resources are configured and initiated by CSI-ReportConfig.

For Type I and Type II CSI feedback on PUSCH, a CSI report comprises of two parts. Part 1 has a fixed payload size and is used to identify the number of information bits in Part 2. Part 1 shall be transmitted in its entirety before Part 2. For Type I CSI feedback, Part 1 contains RI (if reported), CRI (if reported), CQI for the first codeword (if reported). Part 2 contains PMI (if reported), LI (if reported) and contains the CQI for the second codeword (if reported) when RI is larger than 4. For Type II CSI feedback, Part 1 contains RI (if reported), CQI, and an indication of the number of non-zero wideband amplitude coefficients per layer for the Type II CSI (see clause 5.2.2). The fields of Part 1-RI (if reported), CQI, and the indication of the number of non-zero wideband amplitude coefficients for each layer—are separately encoded. Part 2 contains the PMI and LI (if reported) of the Type II CSI. The elements of i_{1,4,l}, i_{2,1,l} (if reported) and i_{2,2,l} (if reported) are reported in the increasing order of their indices, i=0,1, . . . , L-1, where the element of the lowest index is mapped to the most significant bits and the element of the highest index is mapped to the least significant bits. Part 1 and 2 are separately encoded.

When CSI reporting on PUSCH comprises two parts, the UE may omit a portion of the Part 2 CSI. Omission of Part 2 CSI is according to the priority order shown in Table 5.2.3-1 in TS 38.214 [REF4].

When the PUCCH carry Type I CSI with wideband frequency granularity, the CSI payload carried by the PUCCH format 2 and PUCCH formats 3, or 4 are identical and the same irrespective of RI (if reported), CRI (if reported). For type I CSI sub-band reporting on PUCCH formats 3, or 4, the payload is split into two parts. The first part contains RI (if reported), CRI (if reported), CQI for the first codeword. The second part contains PMI and contains the CQI for the second codeword when RI>4.

A semi-persistent report carried on the PUCCH formats 3 or 4 supports Type II CSI feedback, but only Part 1 of Type II CSI feedback (See clause 5.2.2 and 5.2.3 in TS 38.214 [REF4]). Supporting Type II CSI reporting on the PUCCH formats 3 or 4 is a UE capability type2-SP-CSI-Feedback-LongPUCCH. A Type II CSI report (Part 1 only) carried on PUCCH formats 3 or 4 shall be calculated independently of any Type II CSI reports carried on the PUSCH (see clause 5.2.3 in TS 38.214 [REF4]).

If any of the CSI reports includes two parts, the UE may omit a portion of Part 2 CSI. Omission of Part 2 CSI is according to the priority order shown in Table 5.2.3-1 in TS 38.214 [REF4]. Part 2 CSI is omitted beginning with the lowest priority level until the Part 2 CSI code rate is less or equal to the one configured by higher layer parameter maxCodeRate.

Present networks have limited capability to adapt an operation state in one or more of time/frequency/spatial/power domains. For example, in NR, there are transmissions or receptions by a serving gNB that are expected by UEs, such as transmissions of synchronization signal/physical broadcast channels (SSB/PBCH) blocks, or of system information, or of CSI-RS indicated by higher layers, or receptions of physical random access channel (PRACH) or SRS indicated by higher layers. Reconfiguration of a NW operation state involves higher layer signaling by a SIB or by UE-specific RRC. That is a slow process and requires substantial signaling overhead, particularly for UE-specific RRC signaling. For example, it is currently not practical or possible for a network in typical deployments to enter an energy saving state where the network 130 does not transmit or receive due to low traffic as, in order to obtain material energy savings, the network 130 needs to suspend transmissions or receptions for several tens of milliseconds and preferably for even longer time periods. A similar inability exists for suspending transmission or receptions for shorter time periods as a serving gNB may need to frequently transmit SS/PBCH blocks, such as every 5 msec or every 20 msec and, in TDD systems with UL-DL configurations having few UL symbols in a period, the serving gNB may need to receive PRACH or SRS in most UL symbols in a period.

Due to the one or more reasons described herein, adaptation of a NW operation state is typically over long time periods, such as for off-peak hours when an amount of served traffic is small and for peak hours when an amount of served traffic is large. Therefore, a capability of a gNB to improve service by fast adaptation of a NW operation state to the traffic types and load, or to save energy by switching to a state that requires less energy consumption when an impact on service quality would be limited or none, is currently limited as there are no procedures for a serving gNB to perform fast adaptation of a NW operation state with small signaling overhead while simultaneously informing all UEs of the NW 130 operation state.

It is also beneficial to support a gradual transition of NW operation states between a maximum state where the NW 130 operates at its maximum capability in one or more of a time/frequency/spatial/power domain and a minimum state where the NW 130 operates at its minimum capability, or the NW 130 enters a sleep mode. That would allow continuation of service while the NW 130 transitions from a state with larger utilization of time/frequency/spatial/power resources to a state with lower utilization of such resources and the reverse as UEs can obtain time/frequency synchronization and automatic gain control (AGC) alignments, perform measurements, and provide CSI reports or transmit SRS prior to scheduling of PDSCH receptions or PUSCH transmissions.

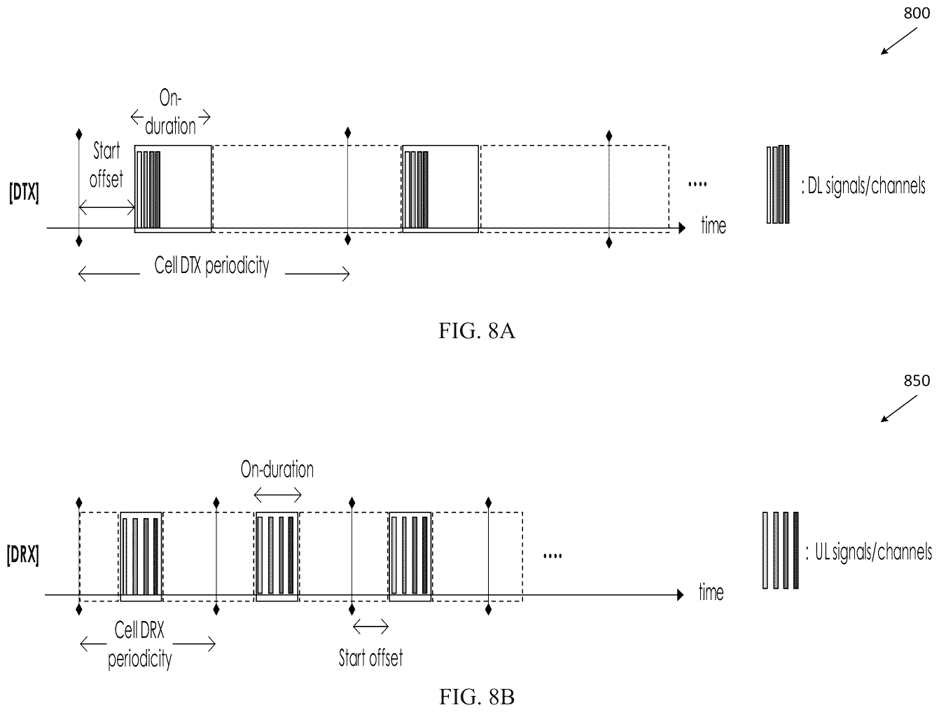

FIGS. 8A and 8B illustrate timelines for example cell DTX and DRX 800 and 850, respectively, according to embodiments of the present disclosure. For example, DTX 800 and DRX 850 can be followed by the BS 102 of FIG. 1. This example is for illustration only and other embodiments can be used without departing from the scope of the present disclosure.

In order to enable a gNB to sleep and save energy while minimizing an impact on served UEs, the gNB 102 can apply discontinued transmissions (cell DTX) or discontinued receptions (cell DRX) on a serving cell. UEs in the cell can be informed of corresponding cell DTX/DRX configurations such that the UEs can operate accordingly and avoid power consumption when the serving gNB is in dormancy (cell DTX/DRX). By turning off all or a part of a transmission chain and pausing transmission during the cell DTX, the gNB 102 can reduce energy consumption for standby when there is little to no traffic. For cell DTX, a UE may assume that all transmissions from a serving gNB are suspended or the UEs may assume that some signals, such as primary synchronization signal (PSS) or secondary synchronization signal (SSS) for maintaining synchronization, remain present during cell DTX. By turning off all or a part of receiver chain and pausing receptions during the cell DRX, the gNB 102 can reduce energy consumption for standby when there is little to no traffic. For cell DRX, a UE may assume that all transmissions from the UE 116 are suspended or may assume that some transmissions, such as ones required for initial access such as PRACH, are allowed during a cell DRX duration.

As illustrated in FIG. 8, cell DTX/DRX can be configured via at least a periodicity, a start slot/offset, and an on-duration. A UE assumes that all transmissions/receptions by the gNB 102 are enabled during the DTX/DRX on-duration, respectively. The configurations and operations of cell DTX and cell DRX can be linked or can be separate, for example depending on DL/UL traffic characteristics.

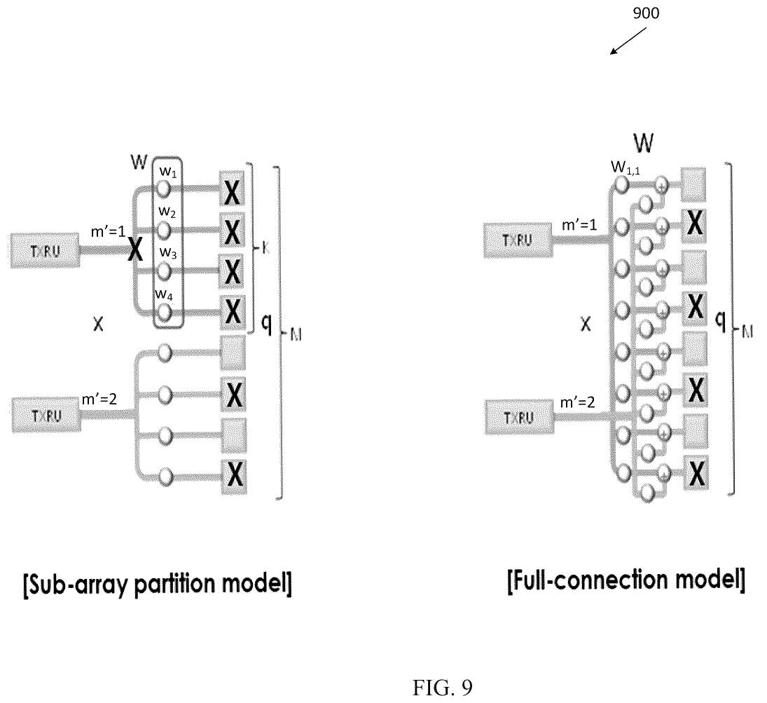

FIG. 9 illustrates diagrams of example spatial domain adaptations 900 according to embodiments of the present disclosure. For example, spatial domain adaptations 900 can be implemented by the BS 103 of FIG. 1. This example is for illustration only and other embodiments can be used without departing from the scope of the present disclosure.

The energy consumption by power amplifiers (PA) for each set of antenna elements (AEs) accounts for a large portion of total energy consumption by a gNB equipped with massive MIMO antennas. For network energy savings, when the traffic load is low, the gNB 102 can turn off a subset of PAs or reduce the PA output power levels. For brevity, such operation is respectively referred to as spatial domain (SD) or power domain (PD) adaptation in this embodiment of the disclosure. Unlike cell DTX/DRX illustrated in FIG. 8, one advantage of SD/PD adaptation is that the network 130 can maintain continuity of transmissions and receptions without interruptions by operating at a reduced capability.

A gNB can enable/disable all AEs associated to a logical antenna port or enable/disable a subset of AEs associated to a logical antenna port. For brevity, those adaptations of AEs are respectively referred to as Type 1 and Type 2 SD adaptations in this embodiment of the disclosure. The gNB 102 may perform Type 1 SD adaptation, or Type 2 SD adaptation, or both.

With reference to FIG. 5, in a hybrid beamforming system, one antenna port is connected to a large number of AEs that can be controlled by a bank of analog phase shifters, which is referred to as TxRU virtualization. With reference to FIG. 9, the TxRU virtualization can be implemented based on sub-array partition model, full-connection model, or combinations of them. In a sub-array partition model, spatial element adaptations can result in both Type 1 and Type 2 SD adaptations. In case of Type 1 SD adaptation, both the PAs connected to AEs associated to a logical antenna port and the subsequent RF chain, e.g., ADC/DAC, etc., associated to the logical antenna port can be turned off. In a full-connection model, spatial element adaptations can only result in Type 2 SD adaptations unless all the antenna ports are turned off.

The impact of Type 1 SD adaptation results in a change in the number of active antenna ports or antenna structure in general. The RF characteristics, e.g., radiation power, beam pattern, etc., of remaining antenna ports remain same. The impact of Type 2 SD adaptation results in a change in the RF characteristics of antenna ports affected by AE on/off while the number of antenna ports remains the same. The impact of PD adaptation is similar to Type 2 SD adaptation. A gNB can perform any combination of Type 1 SD, Type 2 SD, and PD adaptations together with other time/frequency domain adaptation techniques such as cell DTX/DRX.

A network may want to assess an impact of spatial and power domain adaptations prior to executing an actual adaptation by receiving multiple CSI reports corresponding to different hypotheses of SD/PD adaptations from UEs. Providing multiple CSI-RS resource configurations individually for different hypotheses can be inefficient and lead to excessive signaling overhead as they may be derived as multiple sub-configurations from a single baseline configuration. Therefore, embodiments of the present disclosure recognize there is a need for defining procedures and methods to efficiently provide multiple CSI-RS resource configurations corresponding to different hypotheses to UEs.

If multiple CSI reports are sent in one PUCCH or PUSCH transmission and each of them are treated independently of the other CSI reports, a total payload size for the multiple CSI reports would increase linearly with the number of reports and that can lead to excessive overhead or an inability to reliably provide the multiple CSI reports due to the large payload size. Therefore, there is another need to enhance the CSI reporting mechanism to reduce the total payload for multiple CSI reports associated with different hypotheses of SD/PD adaptations.

Providing multiple CSI reports corresponding to multiple SD/PD parameters in one PUCCH or PUSCH transmission can lead to excessive overhead or an inability to reliably provide the multiple CSI reports due to the large payload size. Therefore, there is a need to enhance CSI reporting mechanism such that the multi-CSI report can be split and sent in more than one reporting instances.

A serving cell can configure a UE to perform neighboring cell measurement and reporting per measurement configuration including intra/inter-RAT and intra/inter-frequencies. A UE can be configured to use SSB or CSI-RS for the measurement. When CSI-RS is used for neighboring cell measurement, the referenceSignalConfig in the MeasObject points to a CSI-RS resource configuration with a corresponding cell ID, measurement bandwidth, and slot configuration for the measurement. When SSB is used for neighboring cell measurement, SSB configuration pointed by referenceSignalConfig and SMTC (SSB measurement timing configuration) are provided to UE. When the neighboring cell is in network energy saving (NES) via SD/PD adaptation, the gNB 102 may operate at a lower transmission power level than its nominal operation, which may discourage UEs to select/reselect or handover to the corresponding cell. Therefore, there is a need to define a mechanism to indicate that a cell is in NES mode and a potential power offset between its normal mode of operation and NES mode for cell selection/reselection or for neighboring cell measurement.

The disclosure relates to a communication system. The disclosure relates to defining functionalities and procedures for adapting a network operation state in a spatial domain or a power domain.

The disclosure also relates to defining procedures and methods for a gNB to provide a number of configurations for CSI-RS resources corresponding to different hypotheses for spatial and power domain adaptations to UEs.

The disclosure further relates to defining procedures and methods for reducing an overhead of sending multiple CSI reports by a UE that are associated with a number of configurations for CSI-RS resources corresponding to different hypotheses for spatial and power domain adaptations.

The disclosure additionally relates to enhance CSI reporting mechanism such that the multi-CSI report can be split and sent in more than one reporting instances.

The disclosure further relates to defining a mechanism to indicate that a cell is in NES mode and a potential power offset between its normal mode of operation and NES mode or for cell DTX/DRX for cell selection/reselection or for neighboring cell measurement.

A description of example embodiments is provided on the following pages.

The text and figures are provided solely as examples to aid the reader in understanding the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

The below flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Embodiments of the disclosure for enabling a serving gNB to perform spatial or power domain adaptations, for example in order to support network energy savings, are summarized in the following and are fully elaborated further herein.
Method and apparatus for a gNB to provide a number of hypotheses on adaptation/configuration of CSI-RS resources by indicating a subset of CSI-RS antenna ports from a given CSI-RS resource configuration such as at the code-division multiplexing (CDM) group level or at the antenna port level within a CDM group.
Method and apparatus for reducing an overhead associated with multiple CSI reports from a UE that correspond to multiple SD/PD adaptation hypotheses via the gNB indicating indexes of configurations for CSI-RS resources for CSI reporting by UEs, limiting a total number of CSI reports, separately configuring CSI report quantities, or compressing multiple PMI matrixes of the same size.
Method and apparatus for enhancing CSI reporting mechanism such that the multi-CSI report can be split and sent in more than one reporting instances.
Method and apparatus for indicating that a cell is in NES mode and a potential power offset between its normal mode of operation and NES mode or for cell DTX/DRX for cell selection/reselection or for neighboring cell measurement.

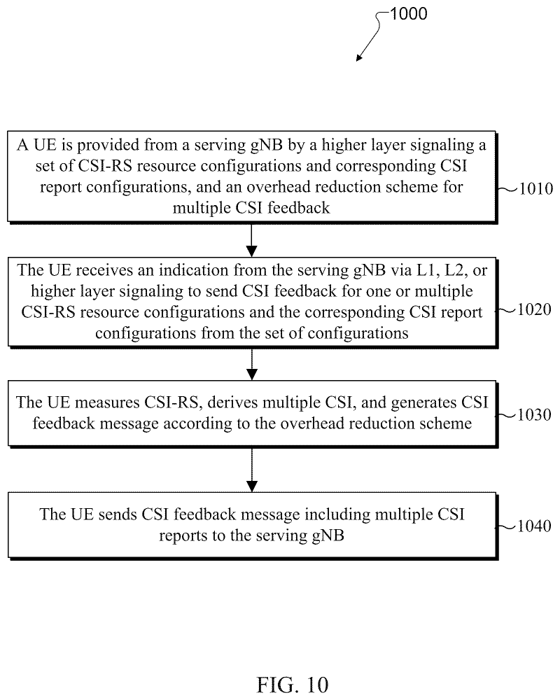

FIG. 10 illustrates a flowchart of an example UE procedure 1000 for measuring and reporting multiple CSI(s) according to embodiments of the present disclosure. For example, procedure 1000 for measuring and reporting multiple CSI(s) can be performed by any of the UEs 111-116 of FIG. 1. This example is for illustration only and other embodiments can be used without departing from the scope of the present disclosure.

The procedure begins in 1010, a UE is provided from a serving gNB by a higher layer signaling a set of configurations for CSI-RS resources and a set of configurations for corresponding CSI reports, and a configuration for an overhead reduction scheme for multiple CSI reports. In 1020, the UE 116 receives an indication from the serving gNB via L1, L2, or higher layer signaling to send CSI feedback for one or multiple CSI-RS resource configurations and the corresponding CSI report configurations from the set of configurations. In 1030, the UE 116 measures CSI-RS, derives multiple CSI, and generates CSI feedback message according to the overhead reduction scheme. In 1040, the UE 116 sends CSI feedback message including multiple CSI reports to the serving gNB.

A serving gNB can indicate to a UE a number of hypotheses on SD/PD adaptations and the UE 116 can provide to the serving gNB a number of CSI reports according to the indicated hypotheses. A number of adaptations/configurations of CSI resources/reports can be provided by the serving gNB to the UE 116 via indications for a set of numbers of CSI-RS antenna ports for an indicated CSI-RS resource configuration, of a set of ratios/offsets of a power for CSI-RS transmission relative to a power for SS/PBCH block, or of a set of ratios/offsets of a power for PDSCH transmission relative to a power for CSI-RS transmission.

The gNB 102 can indicate to the UE 116 to perform CSI measurement and reporting according to the provided number of hypotheses on adaptation/configuration of CSI-RS resources/CSI reports that is referred to, for brevity, as multi-CSI measurement and reporting. The signaling for multi-CSI measurement and reporting can be via a PDCCH providing DCI, or via a PDSCH providing MAC-CE or RRC information. The signaling can be UE-specific, UE-group-specific, or cell-specific for example via a SIB. For example, a UE can monitor PDCCH for detecting a DCI format triggering a multi-CSI report along with an indication of a set of indexes for configurations of CSI-RS resources/CSI reports, or for detecting a DCI format scheduling a PDSCH reception with the MAC CE or RRC information providing the set of indexes, according to a CSS set or a USS set.

The number of CSI reports can be the same as the number of hypotheses for antenna ports, CSI-RS-to-SS/PBCH power offsets, or PDSCH-to-CSI-RS power offsets provides to a UE, or can be limited to a predefined or indicated number that is smaller than the number of provided hypotheses in order to reduce CSI reporting overhead. For example, the UE 116 can provide a first CSI report corresponding to a first configuration of CSI-RS resources, such as a default configuration, and a second CSI report corresponding to a second configuration of CSI-RS resources from the set of provided hypotheses other than the first CSI-RS resources that result to a largest CQI value, or to a largest rank, for PDSCH receptions. The second CSI report can be separate from the first CSI report or can be differential to the first CSI report, for example for the CQI, L1-reference signal received power (RSRP) or for the rank.

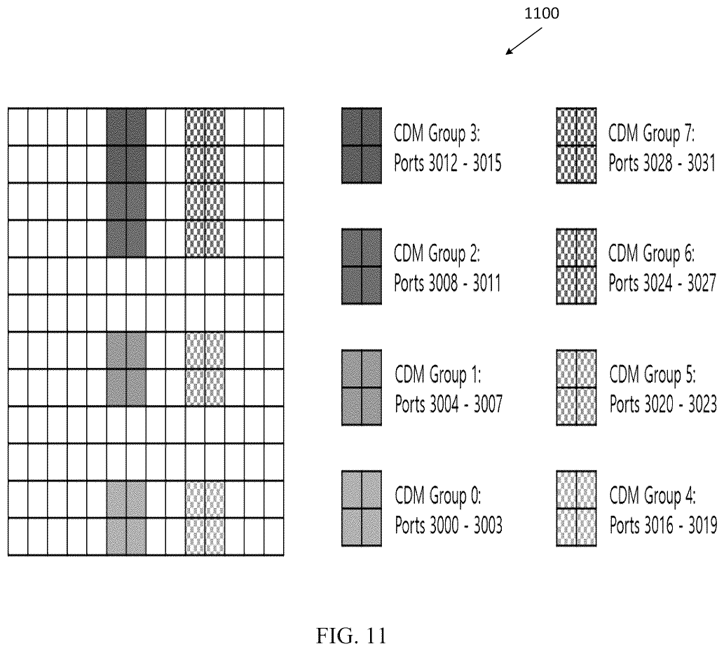

FIG. 11 illustrates a diagram of an example 32 port CSI-RS 1100 according to embodiments of the present disclosure. For example, 32 port CSI-RS 1100 can be implemented in the BS 102 of FIG. 2. This example is for illustration only and other embodiments can be used without departing from the scope of the present disclosure.

With reference to FIG. 11, an example of 32-port CSI-RS based on Row 18 of TS 38.211 [REF1] v.17.5.0 Table 7.4.1.5.3-1 is shown.

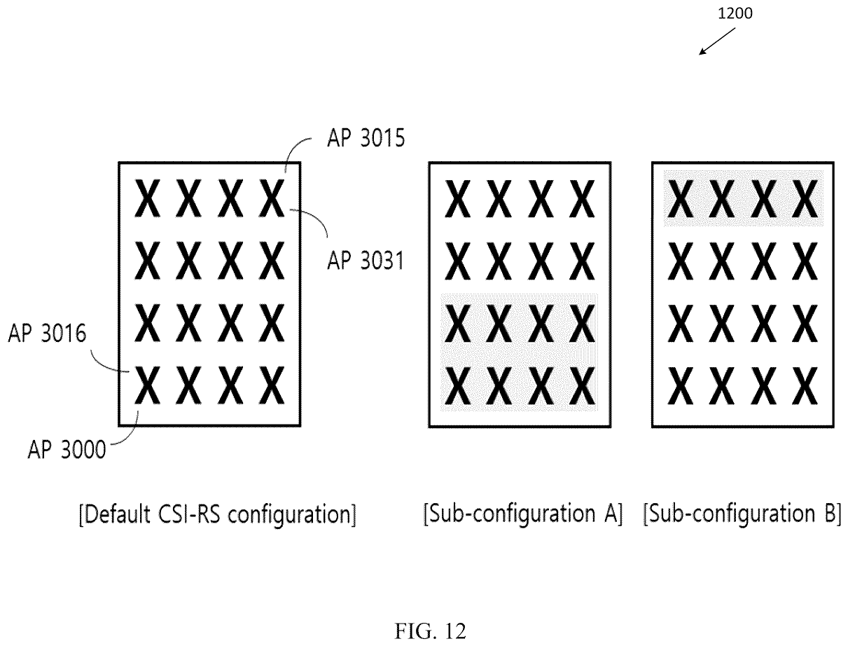

FIG. 12 illustrates a diagram of an example mapping of a 32 port CSI-RS resource 1200 to a 4-by-4 cross polarized antenna system with antenna port AP 3000 to AP 3031 and CDM group-level sub-configurations according to embodiments of the present disclosure. For example, mapping of a 32 port CSI-RS resource 1200 to a 4-by-4 cross polarized antenna system and CDM group-level sub-configurations can be implemented by BS 102 and/or BS 103 of FIG. 1. This example is for illustration only and other embodiments can be used without departing from the scope of the present disclosure.

In one example, with reference to FIG. 12, a default configuration for CSI-RS resources can be provided to the UE 116 using 8 CDM groups as shown in FIG. 11.

For indicating the configuration A in FIG. 12, which corresponds to a lower half of the 4-by-4 cross-polarized antenna system, the UE 116 can be indicated from the serving gNB a bitmap of size 8 with values 11001100, where the value ‘1’ in the i-th bit position indicates that the corresponding i-th CDM group is included in the configuration of CSI-RS resources, where the bit positions are assumed to be labeled from the most significant bit (MSB) to the least significant bit (LSB). If the bit positions are labeled from LSB to MSB, the UE 116 can be indicated from the serving gNB a bitmap providing 00110011 for indicating the same configuration. In the following, it is assumed that the bit positions are labeled from MSB to LSB without loss of generality. For indicating the configuration B of CSI-RS resources in FIG. 12, which corresponds to an upper quarter of the 4-by-4 cross-polarized antenna system, the UE 116 can be indicated from the serving gNB a bitmap of size 8 with values 00010001.

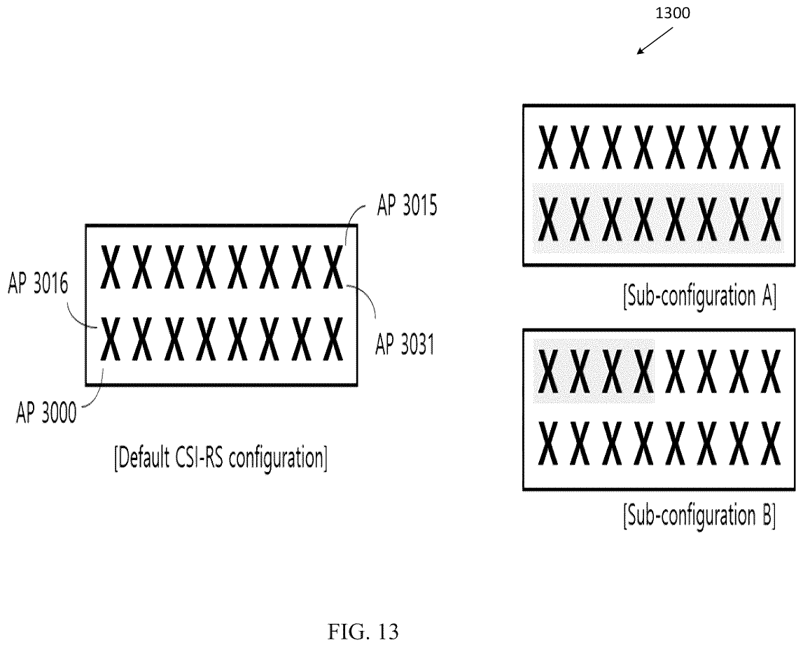

FIG. 13 illustrates a diagram of an example mapping of a 32 port CSI-RS resource 1300 to an 8-by-2 cross polarized antenna system with antenna port AP 3000 to AP 3031 and CDM group-level sub-configurations according to embodiments of the present disclosure. For example, mapping of a 32 port CSI-RS resource 1300 to an 8-by-2 cross polarized antenna system and CDM group-level sub-configurations can be implemented by the BS 102 of FIG. 1. This example is for illustration only and other embodiments can be used without departing from the scope of the present disclosure.

In one example, with reference to FIG. 13, a default configuration of CSI-RS resources can be indicated to the UE 116 using 8 CDM groups as illustrated in FIG. 11.

For indicating the configuration A of CSI-RS resources in FIG. 13, which corresponds to a lower half of the 8-by-2 cross-polarized antenna system, the UE 116 can be indicated from the serving gNB a bitmap of size 8 with values 11001100. For indicating the configuration B of CSI-RS resources in FIG. 13, which corresponds to an upper left quadrant of the 8-by-2 cross-polarized antenna system, the UE 116 can be indicated a bitmap with values 00100010.

In addition to the CDM group-level indications for configurations of CSI-RS resources, a UE can be provided from a serving gNB an antenna port level subset indication.

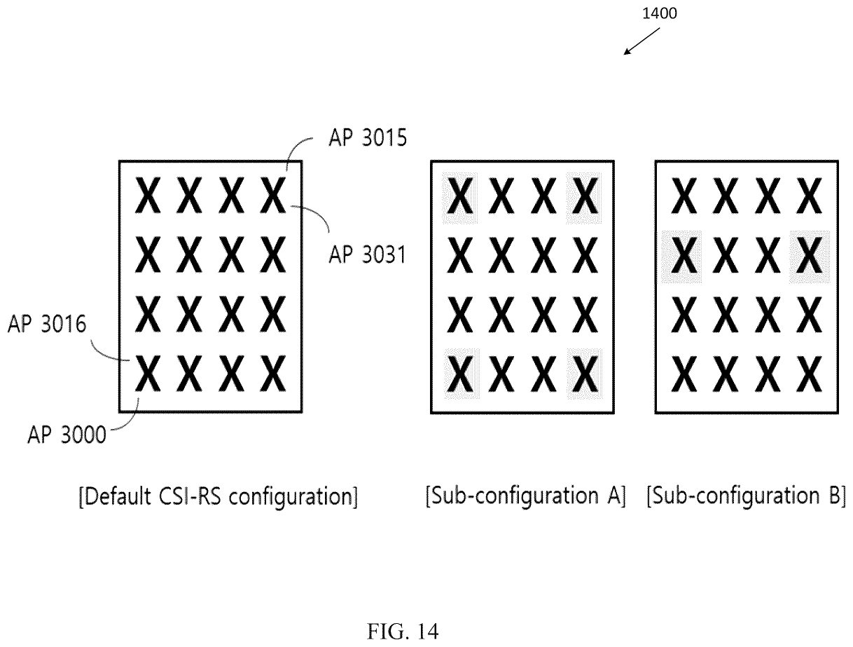

FIG. 14 illustrates a diagram of an example mapping of a 32 port CSI-RS resource 1400 to a 4-by-4 cross polarized antenna system and antenna port level sub-configurations according to embodiments of the present disclosure. For example, mapping of a 32 port CSI-RS resource 1400 to a 4-by-4 cross polarized antenna system and antenna port level sub-configurations can be implemented by the BS 103 of FIG. 1. This example is for illustration only and other embodiments can be used without departing from the scope of the present disclosure.

In one example, with reference to FIG. 14, the default CSI-RS resource can be configured to the UE 116 using 8 CDM groups as illustrated in FIG. 11.

The configuration A of CSI-RS resources in FIG. 14 corresponds to 4 cross-polarized antennas at each of the corners, which are AP 3000, 3003, 3012, 3015, 3016, 3019, 3028, and 3031. In one example, the UE 116 can be indicated the antenna port subset via a bitmap with size is equal to a total number of configured antenna ports. That is, for configuration A, the bitmap has size of 32 bits with values 10010000000010011001000000001001. Alternatively, the UE 116 can be indicated from the serving gNB in two bitmaps: a first bitmap of size 8 at the CDM group-level and a second bitmap of size 4 at the antenna port level within a CDM group. Accordingly, the UE 116 can be indicated from the serving gNB a bitmap with values 10011001 at the CDM group level, indicating that CDM group 0, 3, 4, and 7 are included in the configuration of CSI-RS resources, and a bitmap with values 1001 at the antenna port level, indicating that the first and the last antenna ports within the CDM group of 4 antenna ports are activated in each of the indicated CDM groups. Similarly, the serving gNB can indicate the configuration B of CSI-RS resources to the UE 116 using a bitmap with values 00100010 at the CDM group level and a bitmap with values 1001 at the antenna port level. In indicating CSI-RS resource configurations via CDM group indexes and antenna port index within a CDM group, the serving gNB can ensure uniformity of antenna spacing at the gNB 102.

A number of hypotheses on adaptation/configuration of CSI-RS resources provided from the serving gNB to the UE 116 can also include a set of hypotheses on a power for CSI-RS transmission provided via powerControlOffsetSS which is a power offset of NZP CSI-RS REs to SSS REs and a set of hypotheses on a power for PDSCH transmission provided via powerControlOffset which is a power offset of PDSCH REs to NZP CSI-RS REs. In indicating multiple hypothesis on the CSI-RS transmission power, the UE 116 may be indicated with one or more of powerControlOffsetSS, where the UE 116 is additionally indicated to one powerControlOffsetSS value that is linked to the actual transmission power of CSI-RS. For other indicated powerControlOffsetSS values, the UE 116 calculates the offset from the true powerControlOffsetSS value and scales the measured CSI-RS channel coefficients by the amount of the offset. Alternatively, the UE 116 may be indicated with only the true powerControlOffsetSS value that is linked to the actual transmission power of CSI-RS and a set of offset values relative to the true powerControlOffsetSS value for a number of hypothesis of adaptations. After scaling the measured CSI-RS channel coefficients accordingly, the UE 116 assumes that the power offset between CSI-RS and PDSCH, indicated by powerControlOffset, is maintained for calculating CSI, e.g., when the CSI-RS transmission power is hypothetically assumed to be changes, the PDSCH transmission power is equally changed by the amount of CSI-RS transmission power change, unless otherwise indicated. If separate powerControlOffset values are indicated for a given hypothesis of CSI-RS transmission power change, the UE 116 shall apply the indicated value for the derivation of CSI. Similarly, the UE 116 may be indicated with only one default powerControlOffset value and, for a number of hypothesis of PDSCH power adaptation, only a set of offset values relative to the default powerControl Offset value are provided to the UE 116.

A UE is also provided from a serving gNB by higher layer signaling a number of codebook configurations corresponding to configurations of CSI-RS resources. If a number of hypotheses on adaptation/configuration of CSI-RS resources provided from the serving gNB to the UE 116 include different CSI-RS resourceMapping patterns, the UE 116 is provided from the serving gNB more than one codebook configurations for different CSI-RS resourceMapping patterns. As an example, a UE can be provided from the serving gNB more than one n1-n2, ng-n1-n2, or n1-n2-codebookSubsetRestriction configurations, for a type1-SinglePanel, type1-MultiPanel, and typeII codebook configurations, respectively. If a number of hypotheses on adaptation/configuration of CSI-RS resources is based on a single CSI-RS resourceMapping pattern and different power offset values, such as powerControlOffset, powerControlOffsetSS, a single codebook configuration can be reused by the UE 116 for reporting CSI for a number of hypotheses. In another example, a UE can be configured with a mixed set of codebook types for multi-CSI reports corresponding to a number of SD/PD adaptation hypotheses. For instance, the UE 116 can be indicated by the serving gNB a typeII codebook for a first report corresponding to a first configuration of CSI-RS resources and type1-SinglePanel codebook for a second CSI report corresponding to a second configuration of CSI-RS resources from the set of provided hypotheses other than the first configuration of CSI-RS resources.

With reference to 1020, the UE 116 receives an indication from the serving gNB via L1, L2, or RRC signaling to provide CSI reports for one or multiple hypotheses of SD/PD adaptations from the set of configurations. The signaling for multi-CSI measurement and reporting can be via a PDCCH providing DCI, or via a PDSCH providing MAC-CE, or with RRC information related to the CSI measurements and reporting. The signaling can be UE-specific, UE-group-specific, or cell-specific such as in a SIB. For example, a UE can monitor PDCCH for detecting a DCI format triggering multi-CSI reporting, or for a DCI format scheduling a PDSCH reception with the MAC CE or RRC information, according to a CSS set (UE-group-specific) or a USS set (UE-specific).

In one example, the UE 116 receives an indication from the serving gNB to perform multi-CSI measurement and reporting via a PDCCH providing DCI. The DCI may also provide one or more indexes of configurations for CSI-RS resources/CSI reports, for example using a bitmap, from a set of configurations provided in advance by higher layer signaling. A new DCI format can be defined or an existing DCI format can be extended to include additional fields to indicate to a UE to perform multi-CSI measurement and reporting and provide indexes to configurations of CSI-RS resources/CSI reports, indexes to CSI-RS-to-SS/PBCH transmission power offset parameters and/or indexes to PDSCH-to-CSI-RS transmission power offset parameters. For a semi-persistent or an aperiodic CSI report on a PUSCH, a DCI format scheduling a PUSCH transmission, such as DCI format 0_1, can be extended to include aforementioned fields. Alternatively, multi-CSI measurement and reporting along with indexes to configurations of CSI-RS resources/CSI reports can be defined as ‘Trigger States’ and provided by the serving gNB to the UE 116 by higher layer signaling, and a ‘Trigger State’ can be indicated to the UE 116 using a values of a ‘CSI request’ field in the DCI. For periodic and semi-persistent CSI reporting, the DCI can also provide an update on one or more indexes of configurations for CSI-RS resources and/or CSI reports for the UE 116 to perform measurement and reporting. For periodic and semi-persistent CSI reporting, the DCI can also indicate skipping the corresponding multi-CSI reporting. As an example, the DCI can include one-bit indication for the UE 116 whether to skip the next following multi-CSI measurement and reporting or not. As another example, the DCI can include N-bit indication for the following 2N-1 multi-CSI measurement and reporting. For instance, if N=2, the codepoints 00, 01, 10, 11 indicate no skipping, skipping the next one report, skipping the next two consecutive reports, and skipping the next three consecutive reports out of the next three multi-CSI measurement and reporting, respectively. As yet another example, the DCI can include N-bit bitmap for the indication of the following N multi-CSI measurement and reporting, where i-th bit in the bitmap indicates whether the particular next i-th multi-CSI measurement and reporting is skipped or not.

In another example, the UE 116 receives an indication from the serving gNB to perform multi-CSI measurement and reporting via PDSCH providing MAC-CE or RRC information together with one or multiple indexes to configurations of CSI-RS resources/CSI reports, for example using a bitmap, from the set of configurations provided by higher layer signaling. An existing MAC-CE format can be extended to include additional fields to indicate those indexes, or a new MAC-CE format can be defined. For instance, for a semi-persistent CSI report on PUCCH, the ‘SP CSI reporting on PUCCH Activation/Deactivation’ MAC CE can be extended to include a field providing an index to a configuration of CSI-RS resources/CSI report from the set of configurations provided by higher layer signaling. For a periodic CSI report, the UE 116 can be indicated from the serving gNB a number of hypotheses on SD/PD adaptation/configuration and the periodicity and timing offset for providing multi-CSI report.

With reference to 1030, the UE 116 measures CSI-RS, derives multiple CSI reports, and provides the CSI reports according to the overhead reduction scheme. An overhead reduction scheme can be provided by the serving gNB to the UE 116 as a part of step 1010, or 1020, or it can be predefined and known by the UE 116, e.g., by specifications.

As an example of an overhead reduction scheme, a UE is configured with N₁ configurations for CSI-RS resources/CSI reports by higher layers in step 1010 and is indicated by the serving gNB to provide CSI reports for N₂ indexes of configurations (≤N₁) which can be provided in step 1010 or 1020.

As another example, the UE 116 is configured with N₁ configurations of CSI-RS resources/CSI reports by higher layers in step 1010 and is indicated by the gNB 102 to provide a total of N₂ CSI reports, where N₂ can be provided in step 1010 or 1020 or defined by the specifications. The UE 116 then selects a total of N₂ reports based on criteria and provide the CSI reports together with indexes of the reported configurations as uplink control information (UCI). A criterion for selecting the N₂ of CSI reports from N₁ configurations for CSI reports can be, for instance, based on the ordering of CQI value or rank for PDSCH receptions. The criteria, and the number N₂ of CSI reports, can be indicated by the gNB 102 via higher layers or defined in the specifications of the system operation.

As yet another example, the UE 116 can be separately configured with CSI report quantities for different reports within a multi-CSI report. For instance, the UE 116 can be indicated to report one set of CSI report quantities, e.g., cri-RI-LI-PMI-CQI, for the CSI report corresponding to a first configuration of CSI-RS resources/CSI report and the UE 116 can be indicated to report another set of CSI report quantities, e.g., cri-RI-CQI, for the CSI report corresponding to a second configuration of CSI-RS resources/CSI report, and so on.

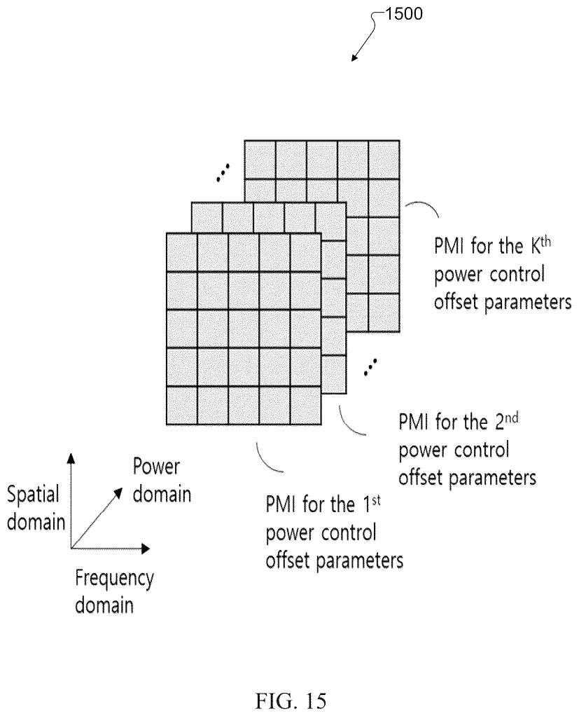

FIG. 15 illustrates a diagram of an example PMI compression 1500 according to embodiments of the present disclosure. For example, PMI compression 1500 can be implemented by any of the UEs 111-116 of FIG. 1. This example is for illustration only and other embodiments can be used without departing from the scope of the present disclosure.

As yet another example, if a same codebook configuration, i.e., codebook type and size, is used for providing more than one CSI reports, the PMI reporting can be compressed across the multiple PMI matrixes in addition to the spatial and frequency domain PMI compression, e.g., by selecting additional discrete Fourier transform (DFT) basis set along the new dimension and representing the set of PMI matrixes via a linear combination of the chosen DFT basis sets in different domains.

FIG. 15 illustrates PMI compression in three dimensions according to the disclosure. As an example, if a number of hypotheses on adaptation/configuration of CSI-RS resources is based on a single CSI-RS resourceMapping pattern for different power offset values, e.g., powerControlOffset or powerControlOffsetSS, the PMI matrixes derived for the different hypotheses may have the same dimensions. In such case, multiple PMI matrixes of the same size can be stacked and further compressed as illustrated in FIG. 15. With reference to 1040, the UE 116 then provides a CSI report including multiple CSI reports to the serving gNB.

Providing multiple CSI reports corresponding to multiple SD/PD parameters in one PUCCH or PUSCH transmission can lead to excessive overhead or an inability to reliably provide the multiple CSI reports due to the large payload size. In one embodiment, the serving gNB can provide more than one PUCCH resources for periodic CSI reporting and semi-persistent CSI reporting on PUCCH. The multiple PUCCH resources can be provided by serving gNB to UE via higher layer signaling, for instance, in reportConfigType in CSI-ReportConfig. When more than one PUCCH resources are provided, the report periodicity and offset, i.e., CSI-ReportPeriodicityAndOffset, need to be indicated for each of the corresponding PUCCH resources. In one example, CSI-ReportPeriodicityAndOffset can be separately signaled for each of the provided PUCCH resources. In another example, the resources other than the first PUCCH resource assumes the same periodicity indicated for the first PUCCH resource, while only the offset value is separately indicated for each resource, where the offset can be indicated relative to the first PUCCH resource, or the preceding PUCCH resource, i.e., offset for the 3^{rd} PUCCH resource is indicated relative to the 2^{nd} PUCCH resource. Similarly, the serving gNB can provide more than one PUSCH resources for aperiodic CSI reporting and semi-persistent CSI reporting on PUSCH. The multiple PUSCH resources are provided by serving gNB to UE via DCI triggering CSI report, e.g., DCI format 0_1, as well as the report slot offset from the reportSlotOffsetList provided via higher layer signaling.

In the following example, the description is provided for the case when there are two PUCCH resources. However, it can be generally understood for the case of more than two PUCCH resources or for the case of PUSCH resources.

In one example, when the UE 116 is configured with two PUCCH resources for a given multi-CSI report involving N CSI reports, the UE 116 is also indicated a number of CSI reports to be included in the first resource and the second resource, e.g., N1 and N2, where N1+N2=N. Then, for each of the resource, the UE 116 includes a number of CSI reports until a resulting code rate is smaller than or equal to the indicated code rate (or target block error ratio (BLER) is met for the indicated MCS for the case of PUSCH resource). That is, for the first PUCCH resource, the UE 116 includes CSI report starting from index 0 but not exceeding index N1-1, until the target code rate is maintained. For the second PUCCH resource, the UE 116 includes CSI report starting from index N1 until the target code rate is maintained. In another example, the UE 116 is not provided with such N1 and N2 values, and the UE 116 includes CSI reports in a descending order of CSI reports while the target code rate is maintained. For instance, if K number of reports, indexed from CSI report 0 to K-1, can be included in the first PUCCH resource while maintaining the target code rate, the second PUCCH resource includes CSI reports indexed from CSI report K until the target code rate is maintained. In yet another example, the UE 116 includes CSI part 1 in the first PUCCH resource and CSI part 2 in the second PUCCH resource. If the CSI part 1 cannot be entirely contained in the first PUCCH resource while maintaining the target code rate, the remaining portion of CSI part 1 is sent in the second PUCCH resource. If there are remaining bits in the first PUCCH resource at the target code rate while entirely including CSI part 1, a portion of CSI part 2 can be also included in the first PUCCH resource. If an entirety of CSI part 2 is also sent in the first PUCCH resource, the second PUCCH is not transmitted by the UE 116. When the CSI part 2 cannot be entirely transmitted using both the first and the second PUCCH resources, the UE 116 starts omitting CSI part 2 according to priority reporting levels until the target code rate is maintained. As an example, priority reporting levels such that Part 2 wideband CSI for N CSI reports has the highest priority and then according to a descending order of CSI report index for Part 2 subband CSI with alternation between even subbands and odd subbands.

The one or more examples described herein can be similarly understood for the case of two PUSCH resources or for the case with more than two resources for a multi-CSI reporting.

In one embodiment, a gNB may broadcast in master information block (MIB)/system information block (SIB) that the cell is in NES mode with a potential power offset between its normal mode of operation and NES mode. With such indication, an idle mode UE may (de-) prioritize NES cell over other cells operating in a normal mode. As another example, an idle mode UE may evaluate the indicated potential power offset between its normal mode of operation and NES mode into the measured strength of the cell, e.g., by compensating the measured RSRP/reference signal received quality (RSRQ)/signal to interference and noise ratio (SINR) by the indicated offset, for cell selection/reselection. The gNB 102 may also broadcast cell DTX/DRX information, such as periodicity/offset and on-duration, in MIB/SIB such that the UEs can correctly measure the cell.

A serving cell can configure a UE to perform neighboring cell measurement and reporting per measurement configuration including intra/inter-RAT and intra/inter-frequencies. A UE can be configured to use SSB or CSI-RS for the measurement. When CSI-RS is used for neighboring cell measurement, the referenceSignalConfig in the MeasObject points to a CSI-RS resource configuration with a corresponding cell ID, measurement bandwidth, and slot configuration for the measurement. When SSB is used for neighboring cell measurement, SSB configuration pointed by referenceSignalConfig and SMTC (SSB measurement timing configuration) are provided to UE. In one embodiment, neighboring cells may share whether they are operating in NES mode with a potential power offset between its normal mode of operation and NES mode via X2 or Xn interfaces. The serving cell provides the received information to UEs, e.g., in the MeasObject configuration, for the UE 116 to evaluate the indicated potential power offset between its normal mode of operation and NES mode into the measured strength of the cell, e.g., by compensating the measured RSRP/RSRQ/SINR by the indicated offset. With an indicated power offset values, the UE 116 may use compensated neighboring cell measurement quantities, e.g., RSRP, RSRQ, SINR, for the event triggered radio resource management (RRM) report, e.g., A1-6.

For each DL bandwidth part (BWP) indicated to a UE in a serving cell, the UE 116 can be provided by higher layer signaling with P≤3 control resource sets (CORESETs). For each CORESET, the UE 116 is provided a CORESET index p, 0≤p<12, a DM-RS scrambling sequence initialization value, a precoder granularity for a number of resource element groups (REGs) in the frequency domain where the UE 116 can assume use of a same DM-RS precoder, a number of consecutive symbols for the CORESET, a set of resource blocks (RBs) for the CORESET, CCE-to-REG mapping parameters, an antenna port quasi co-location, from a set of antenna port quasi co-locations indicating quasi co-location information of the DM-RS antenna port for PDCCH reception in a respective CORESET, and an indication for a presence or absence of a transmission configuration indication (TCI) field for DCI format 1_1 transmitted by a PDCCH in CORESET p.

For each DL BWP configured to a UE in a serving cell, the UE 116 is provided by higher layers with S≤10 search space sets. For each search space set from the S search space sets, the UE 116 is provided a search space set index s, 0≤s<40, an association between the search space set s and a CORESET p, a PDCCH monitoring periodicity of kₛ slots and a PDCCH monitoring offset of oₛ slots, a PDCCH monitoring pattern within a slot, indicating first symbol(s) of the CORESET within a slot for PDCCH monitoring, a duration of Tₛ<kₛ slots indicating a number of slots that the search space set s exists, a number of PDCCH candidates Mₛ^{(L)} per CCE aggregation level L, and an indication that search space set s is either a CSS set or a USS set. When search space set s is a CSS set, the UE 116 monitors PDCCH for detection of DCI format 2_x, where x ranges from 0 to 7 as described in TS 38.212 [REF2] v17.4.0, or for DCI formats associated with scheduling broadcast/multicast PDSCH receptions, and possibly for DCI format 0_0 and DCI format 1_0.

A UE determines a PDCCH monitoring occasion on an active DL BWP from the PDCCH monitoring periodicity, the PDCCH monitoring offset, and the PDCCH monitoring pattern within a slot. For search space set s, the UE 116 determines that a PDCCH monitoring occasion(s) exists in a slot with number n_{s,f}^{μ}, in a frame with number n_{f} if (n_{f}·Nₛₗₒₜ^{frame,μ}+n_{s,f}^{μ}−oₛ) mod kₛ=0. The UE 116 monitors PDCCH candidates for search space set s for Tₛ consecutive slots, starting from slot n_{s,f}^{μ}, and does not monitor PDCCH candidates for search space set s for the next kₛ-Tₛ consecutive slots. The UE 116 determines CCEs for monitoring PDCCH according to a search space set based on a search space equation as described in TS 38.213 [REF3] v17.4.0.

A UE expects to monitor PDCCH candidates for up to 4 sizes of DCI formats that include up to 3 sizes of DCI formats with CRC scrambled by C-RNTI per serving cell. The UE 116 counts a number of sizes for DCI formats per serving/scheduled cell based on a number of PDCCH candidates in respective search space sets for the corresponding active DL BWP. In the following, for brevity, that constraint for the number of DCI format sizes will be referred to as DCI size limit. When the DCI size limit would be exceeded for a UE based on a configuration of DCI formats that the UE 116 monitors PDCCH, the UE 116 aligns the size of some DCI formats, as described in TS 38.212 [REF2] v17.4.0, so that the DCI size limit would not be exceeded.

For each scheduled cell, the UE 116 is not required to monitor on the active DL BWP with SCS configuration μ of the scheduling cell more than min (M_{PDCCH}^{max,slot,μ}, M_{PDCCH}^{total,slot,μ}) PDCCH candidates or more than min (C_{PDCCH}^{max,slot,μ}, C_{PDCCH}^{total,slot,μ}) non-overlapped CCEs per slot, wherein, M_{PDCCH}^{max,slot,μ} and C_{PDCCH}^{max,slot,μ} are respectively a maximum number of PDCCH candidates and non-overlapping CCEs for a scheduled cell and M_{PDCCH}^{total,slot,μ} and C_{PDCCH}^{total,slot,μ} are respectively a total number of PDCCH candidates and non-overlapping CCEs for a scheduling cell, as described in TS 38.213 [REF3] v17.4.0.

A UE does not expect to be configured CSS sets, other than CSS sets for multicast PDSCH scheduling, that result to corresponding total, or per scheduled cell, numbers of monitored PDCCH candidates and non-overlapped CCEs per slot on the primary cell that exceed the corresponding maximum numbers per slot. For USS sets or for CSS sets associated with multicast PDSCH scheduling, when a number of PDCCH candidates or non-overlapping CCEs in a slot would exceed the aforementioned limits/maximum per slot for scheduling on the primary cell, the UE 116 selects the USS sets or the CSS sets to monitor corresponding PDCCH in an ascending order of a corresponding search space set index until and an index of a search space set for which PDCCH monitoring would result to exceeding the maximum number of PDCCH candidates or non-overlapping CCEs per slot for scheduling on the PCell as described in TS 38.213 [REF3] v17.4.0.

For same cell scheduling or for cross-carrier scheduling where a scheduling cell and scheduled cells have DL BWPs with same SCS configuration u, a UE does not expect a number of PDCCH candidates and a number of corresponding non-overlapped CCEs per slot on a secondary cell to be larger than the corresponding numbers that the UE 116 is capable of monitoring on the secondary cell per slot. For cross-carrier scheduling, the number of PDCCH candidates for monitoring and the number of non-overlapped CCEs per slot are separately counted for each scheduled cell.

A UE can be configured for operation with carrier aggregation (CA) for PDSCH receptions over multiple cells (DL CA) or for PUSCH transmissions over multiple cells (UL CA). The UE 116 can also be configured multiple transmission-reception points (TRPs) per cell via indication (or absence of indication) of a coresetPoolIndex for CORESETs where the UE 116 receives PDCCH/PDSCH from a corresponding TRP as described in TS 38.213 v17.4.0 and TS 38.214 [REF4] v17.4.0.

MIMO technologies have a key role in boosting system throughput both in NR and LTE and such a role will continue and further expand in the future generations of wireless technologies.

For MIMO operation, an antenna port is defined such that a channel over which a symbol on the antenna port is conveyed can be inferred from the channel over which another symbol on the same antenna port is conveyed. There is not necessarily a one to one correspondence between an antenna port and an antenna element, and a plurality of antenna elements can be mapped onto one antenna port.

For mmWave bands, although a number of antenna elements can be larger than in lower bands for a given form factor, a number of CSI-RS ports, that can correspond to a number of digitally precoded ports, tends to be limited due to hardware constraints (such as the feasibility to install a large number of ADCs/DACs at mmWave frequencies) as illustrated in FIG. 5. In this case, one CSI-RS port is mapped onto a large number of antenna elements which can be controlled by a bank of analog phase shifters. One CSI-RS port can then correspond to one sub-array that produces a narrow analog beam through analog beamforming. This analog beam can be configured to sweep across a wider range of angles by varying the phase shifter bank across symbols, slots, or subframes. The number of sub-arrays (equal to the number of RF chains) is same as the number of CSI-RS ports NCSI-PORT. A digital beamforming unit performs a linear combination across NCSI-PORT analog beams to further increase precoding gain. While analog beams are wideband, and therefore are not frequency-selective, digital precoding can be varied across frequency sub-bands or resource blocks.

To enable digital precoding, it is important to provide an efficient design of CSI-RS in order to address various operating conditions while maintaining a low overhead for CSI-RS transmissions. For that reason, three types of CSI reporting mechanism corresponding to three types of CSI-RS measurement behavior are supported in Rel. 13 LTE: 1) ‘CLASS A’ CSI reporting that corresponds to non-precoded CSI-RS, 2) ‘CLASS B’ CSI reporting with K=1 CSI-RS resource that corresponds to UE-specific beamformed CSI-RS, and 3) ‘CLASS B’ reporting with K>1 CSI-RS resources that corresponds to cell-specific beamformed CSI-RS. For non-precoded (NP) CSI-RS, a cell-specific one-to-one mapping between CSI-RS port and TXRU is utilized. Here, different CSI-RS ports have the same wide beam width and direction and hence generally cell-wide coverage. For beamformed CSI-RS, beamforming operation, either cell-specific or UE-specific, is applied on a non-zero-power (NZP) CSI-RS resource including multiple ports. Here, at least at a given time/frequency resources, CSI-RS ports have narrow beam widths, and hence do not provide cell-wide coverage, and (at least from the eNB perspective) at least some CSI-RS port-resource combinations have different beam directions. The basic principle remains same in NR.

In scenarios where a gNB can measure long-term DL channel statistics for a UE through receptions of signals from the UE 116, such as SRS or DM-RS, UE-specific beamformed CSI-RS can be readily used. This is typically feasible when UL-DL duplex distance is sufficiently small. When that condition does not hold, UE feedback is necessary for the gNB 102 to obtain an estimate of long-term DL channel statistics (or any of its representation thereof). To facilitate such a procedure, a first beamformed CSI-RS transmitted with periodicity T1 (msec) and a second NP CSI-RS transmitted with periodicity T2 (msec), where T1≤T2. This approach is referred to as hybrid CSI-RS. The implementation of hybrid CSI-RS depends on the definition of CSI processes and NZP CSI-RS resources.

One important component of a MIMO transmission scheme is the accurate CSI acquisition at the gNB (or TRP). For MU-MIMO, in particular, availability of accurate CSI is necessary in order to guarantee robust MU performance and avoid interference among transmissions to different UEs. For TDD systems, CSI can be acquired using SRS transmissions from UEs by relying on DL/UL channel reciprocity. For FDD systems, a gNB can acquire CSI by transmitting CSI-RS and obtaining corresponding CSI reports from UEs. A CSI reporting framework can be ‘implicit’ in the form of CQI/PMI/RI, and possibly CRI, as derived from a codebook assuming SU transmission from eNB. Because of the inherent SU assumption while deriving CSI, implicit CSI feedback is inadequate for MU transmissions. For MU-centric operation, a high-resolution Type-II codebook, in addition to low resolution Type-I codebook, can be used.

A serving gNB can configure Type-I and Type-II CSI codebooks to a UE using higher layer signalling to provide a CodebookConfig IE, as described in TS 38.331 [REF5] v17.4.0, that includes the following parameters.
codebookType includes type1, type2 and possibly sub-types such as type1-SinglePanel, typeI-MultiPanel, typeII, and typeII-PortSelection, and corresponding parameters for each type. fgvrt.
n1-n2 configures a number of antenna ports in first (n1) and second (n2) dimension and codebook subset restriction for type1-SinglePanel.
ng-n1-n2 configures a number of antenna panels (ng), a number of antenna ports in first (n1) and second (n2) dimension assuming that the antenna structure is identical for the configured number of panels, and a codebook subset restriction for Type I Multi-panel codebook.
n1-n2-codebookSubsetRestriction configures a number of antenna ports in first (n1) and second (n2) dimension and a codebook subset restriction for typeII.
CodebookConfig-r17 includes type1-SinglePanel1-r17 and type1-SinglePanel2-r17 for type I to enable configuration of different antenna structures for two TRPs.

The IE RS-ResourceMapping indicates a resource element mapping for a CSI-RS resource in the time and frequency domains. The container of the IE includes elements for configuration of time and resources such as frequency domain by firstOFDMSymbolIn Time Domain, firstOFDMSymbolInTimeDomain2, and frequencyDomainAllocation, the CSI-RS density by density, the number of ports by nrofPorts, and others. The IE CSI-RS-ResourceMapping comprises the NZP-CSI-RS-Resource and ZP-CSI-RS-Resource configurations that are included in the CSI-ResourceConfig. The IE CSI-ResourceConfig defines a group of one or more NZP-CSI-RS-ResourceSet, CSI-IM-ResourceSet and/or CSI-SSB-ResourceSet.

The IE CSI-ReportConfig is used to indicate to a UE parameters for providing a periodic or semi-persistent CSI report via PUCCH transmissions on the cell where CSI-ReportConfig is included, or to indicate parameters for providing a semi-persistent or aperiodic CSI report on a PUSCH as triggered by a DCI that the UE 116 receives. The CSI-ReportConfig is set for certain CSI-ResourceConfigId for channel/interference measurements. The aforementioned CodebookConfig is also part of CSI-ReportConfig.

For aperiodic CSI, both aperiodic CSI reporting and aperiodic CSI-RS transmission are triggered using a ‘CSI Request’ field within a DCI format scheduling a PUSCH transmission, such as DCI format 0_1. The ‘CSI Request’ field indicates a ‘Trigger State’ that points to a certain CSI-ReportConfigId and resourcesForChannel, e.g., NZP-CSI-RS-ResourceSet. The ‘CSI Request’ field can have up to 6 bits and can indicate up to 64 ‘Trigger States’. If a UE is configured with more than 64 ‘Trigger States’, a ‘Aperiodic CSI Trigger State Subselection’ MAC CE identifies a subset of Trigger States that are indicated by DCI.

For semi-persistent CSI on PUCCH, the semi-persistent CSI-RS resource is triggered by a “SP CSI-RS/CSI-IM Resource Set Activation/Deactivation” MAC CE that includes a SP CSI-RS resource set ID indicating an index of NZP-CSI-RS-ResourceSet containing Semi Persistent NZP CSI-RS resources indicating the Semi Persistent NZP CSI-RS resource set, that is to be activated or deactivated. Semi-persistent CSI reporting on PUCCH is triggered using the “SP CSI reporting on PUCCH Activation/Deactivation” MAC CE. The field S₁ in the MAC CE indicates the activation/deactivation status of the Semi-Persistent CSI report configuration within csi-ReportConfigToAddModList. So refers to the report configuration that includes PUCCH resources for semi-persistent CSI reporting in the indicated BWP and has the lowest CSI-ReportConfigId within the list with type set to semiPersistentOnPUCCH. SI refers to the report configuration that includes PUCCH resources for semi-persistent CSI reporting in the indicated BWP and has the second lowest CSI-ReportConfigId, and so on.

For semi-persistent CSI reporting on PUSCH, a CSI report is triggered using a ‘CSI Request’ field in a DCI format 0_1 with CRC scrambled by a SP-CSI-RNTI. The operating details are similar to those for an aperiodic CSI report.

For periodic CSI reporting, both reporting and periodic CSI-RS resources are configured and initiated by CSI-ReportConfig.

Present networks have limited capability to adapt an operation state in one or more of time/frequency/spatial/power domains. For example, in NR, there are transmissions or receptions by a serving gNB that are expected by UEs, such as transmissions of SS/PBCH blocks, or of system information, or of CSI-RS indicated by higher layers, or receptions of PRACH or SRS indicated by higher layers. Reconfiguration of a NW operation state involves higher layer signaling by a SIB or by UE-specific RRC. That is a slow process and requires substantial signaling overhead, particularly for UE-specific RRC signaling. For example, it is currently not practical or possible for a network in typical deployments to enter an energy saving state where the network 130 does not transmit or receive due to low traffic as, in order to obtain material energy savings, the network 130 needs to suspend transmissions or receptions for several tens of milliseconds and preferably for even longer time periods. A similar inability exists for suspending transmission or receptions for shorter time periods as a serving gNB may need to frequently transmit SS/PBCH blocks, such as every 5 msec or every 20 msec and, in TDD systems with UL-DL configurations having few UL symbols in a period, the serving gNB may need to receive PRACH or SRS in most UL symbols in a period.

Due to the one or more reasons described herein, adaptation of a NW operation state is typically over long time periods, such as for off-peak hours when an amount of served traffic is small and for peak hours when an amount of served traffic is large. Therefore, a capability of a gNB to improve service by fast adaptation of a NW operation state to the traffic types and load, or to save energy by switching to a state that requires less energy consumption when an impact on service quality would be limited or none, is currently limited as there are no procedures for a serving gNB to perform fast adaptation of a NW operation state with small signaling overhead while simultaneously informing all UEs of the NW 130 operation state.

It is also beneficial to support a gradual transition of NW operation states between a maximum state where the NW 130 operates at its maximum capability in one or more of a time/frequency/spatial/power domain and a minimum state where the NW 130 operates at its minimum capability or the NW 130 enters a sleep mode. That would allow continuation of service while the NW 130 transitions from a state with larger utilization of time/frequency/spatial/power resources to a state with lower utilization of such resources and the reverse as UEs can obtain time/frequency synchronization and AGC alignments, perform measurements and provide CSI reports or transmit SRS prior to scheduling of PDSCH receptions or PUSCH transmissions.

In order to enable a gNB to sleep and save energy while minimizing an impact on served UEs, the gNB 102 can apply discontinued transmissions (cell DTX) or discontinued receptions (cell DRX) on a serving cell. UEs in the cell can be informed of corresponding cell DTX/DRX configurations such that the UEs can operate accordingly and avoid power consumption when the serving gNB is in dormancy (cell DTX/DRX). By turning off all or a part of a transmission chain and pausing transmission during the cell DTX, the gNB 102 can reduce energy consumption for standby when there is little to no traffic. For cell DTX, a UE may assume that all transmissions from a serving gNB are suspended or the UEs may assume that some signals, such as PSS or SSS for maintaining synchronization, remain present during cell DTX. By turning off all or a part of receiver chain and pausing receptions during the cell DRX, the gNB 102 can reduce energy consumption for standby when there is little to no traffic. For cell DRX, a UE may assume that all transmissions from the UE 116 are suspended or may assume that some transmissions, such as ones required for initial access such as PRACH, are allowed during a cell DRX duration.

With reference to FIGS. 8A and 8B, cell DTX/DRX can be configured via at least a periodicity, a start slot/offset, and an on-duration. A UE assumes that all transmissions/receptions by the gNB 102 are enabled during the DTX/DRX on-duration, respectively. The configurations and operations of cell DTX and cell DRX can be linked or can be separate, for example depending on DL/UL traffic characteristics.

The energy consumption by power amplifiers (PA) for each set of antenna elements (AEs) accounts for a large portion of total energy consumption by a gNB equipped with massive MIMO antennas. For network energy savings, when the traffic load is low, the gNB 102 can turn off a subset of PAs or reduce the PA output power levels. For brevity, such operation is respectively referred to as spatial domain (SD) or power domain (PD) adaptation in this embodiment of the disclosure. Unlike cell DTX/DRX illustrated in FIGS. 8A and 8B, one advantage of SD/PD adaptation is that the network 130 can maintain continuity of transmissions and receptions without interruptions by operating at a reduced capability.

A gNB can enable/disable all AEs associated to a logical antenna port or enable/disable a subset of AEs associated to a logical antenna port. For brevity, those adaptations of AEs are respectively referred to as Type 1 and Type 2 SD adaptations in this embodiment of the disclosure. The gNB 102 may perform Type 1 SD adaptation, or Type 2 SD adaptation, or both.

In a hybrid beamforming system as illustrated in FIG. 5, one antenna port is connected to a large number of AEs that can be controlled by a bank of analog phase shifters, which is referred to as TxRU virtualization. With reference to FIG. 9, the TxRU virtualization can be implemented based on sub-array partition model, full-connection model, or combinations of them, as illustrated in FIG. 9. In a sub-array partition model, spatial element adaptations can result in both Type 1 and Type 2 SD adaptations. In case of Type 1 SD adaptation, both the PAs connected to AEs associated to a logical antenna port and the subsequent RF chain, e.g., ADC/DAC, etc., associated to the logical antenna port can be turned off. In a full-connection model, spatial element adaptations can only result in Type 2 SD adaptations unless all the antenna ports are turned off.

The impact of Type 1 SD adaptation results in a change in the number of active antenna ports or antenna structure in general. The RF characteristics, e.g., radiation power, beam pattern, etc., of remaining antenna ports remain same. The impact of Type 2 SD adaptation results in a change in the RF characteristics of antenna ports affected by AE on/off while the number of antenna ports remains the same. The impact of PD adaptation is similar to Type 2 SD adaptation. A gNB can perform any combination of Type 1 SD, Type 2 SD, and PD adaptations together with other time/frequency domain adaptation techniques such as cell DTX/DRX.

To facilitate the decision for determining SD/PD parameters, the network 130 may need to obtain one or multiple CSI reports from a group of UEs regardless of their connected mode DRX (C-DRX) state. Providing individual signaling that triggers CSI measurement and report to a group of UEs via a UE-specific signaling can be inefficient and lead to excessive signaling overhead. Also, the network 130 may want to trigger such group-based CSI measurement and report only when there is a need, i.e., to perform spatial and power domain parameter adaptations. Therefore, there is a need for defining procedures and methods to provide a UE group-based early indication for CSI measurement and report such that the UEs can skip performing CSI measurement and report, if not indicated.

The network 130 may want to collect CSI from a group of UEs sharing a certain property such as those in a particular beam direction or a cell coverage range to facilitate more tailored SD/PD adaptations. Therefore, there is another need for designing an efficient UE-group-specific signaling such as using DCI for providing early indications for CSI measurement and report.

A DCI format providing an early indication for CSI measurement and report can have a size different than sizes of existing DCI formats. Given the limit for number of sizes of DCI formats that a UE can decode from PDCCH receptions per cell, there is yet another need to design a DCI format that provides CSI measurement and report early indication under a present restriction while minimizing or avoiding an increase in size of other DCI formats that the UE 116 monitors corresponding PDCCH.

The disclosure relates to a communication system. The disclosure relates to defining functionalities and procedures for adapting a network operation state in a spatial domain or a power domain.

The disclosure also relates to defining procedures and methods for a gNB to provide and early indication for CSI measurement and report to a group of UEs.

The disclosure further relates to defining UE-group-specific signaling for providing an indication for CSI measurement and report.

The disclosure additionally relates to designing a DCI format that indicates CSI measurement and report under a restriction on a number of sizes of DCI formats that a UE can support while minimizing or avoiding an increase in size of other DCI formats that a UE monitors corresponding PDCCH.

Embodiments of the disclosure for enabling a serving gNB to perform spatial or power domain adaptations, for example in order to support network energy savings, are summarized in the following and are fully elaborated further herein.
Method and apparatus for a gNB to provide configurations for periodic PDCCH monitoring by UEs for detecting a DCI format providing an indication for CSI measurement and report and for UEs to monitor PDCCH for detecting the DCI format and for performing associated CSI measurement and reporting.
Method and apparatus for a gNB to provide a UE-group-specific signaling for providing an indication to UEs for CSI measurement and report.
Method and apparatus for designing a DCI format providing an indication for CSI measurement and report under a constraint for a number of sizes of DCI formats that a UE can decode.

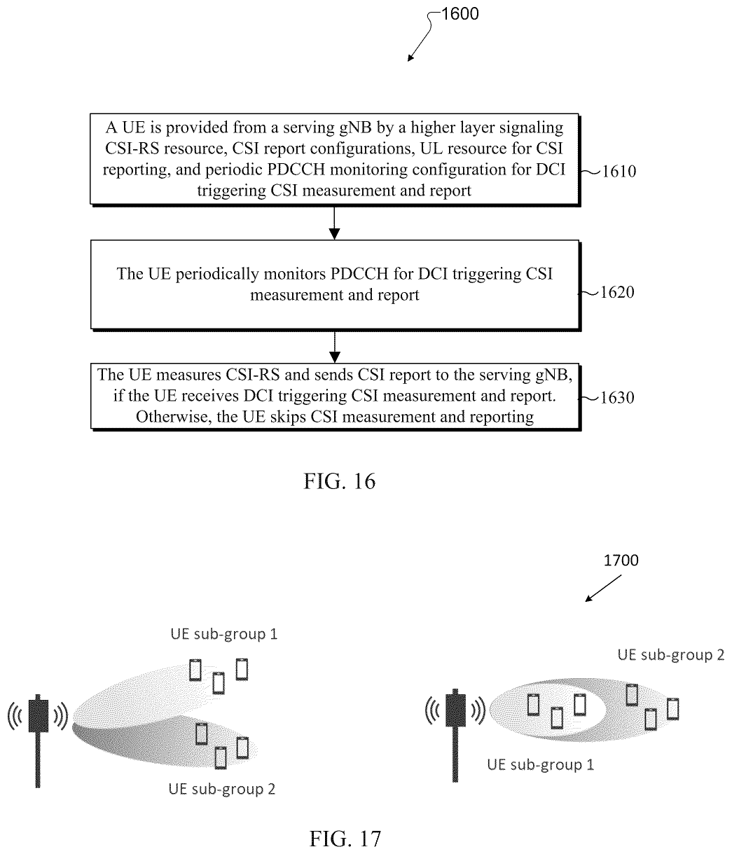

FIG. 16 illustrates a flowchart of an example UE procedure 1600 for measuring and reporting CSI according to embodiments of the present disclosure. For example, UE procedure 1600 for measuring and reporting CSI can be performed by the UE 116 of FIG. 3. This example is for illustration only and other embodiments can be used without departing from the scope of the present disclosure.

The procedure begins in 1610, a UE is provided from a serving gNB by higher layers a configuration for CSI-RS resources and for associated CSI reports, an UL resource such as a PUCCH resource for CSI reporting, and a search space set for PDCCH monitoring for detection of a DCI format that triggers CSI-RS measurement and CSI report. The configurations for CSI-RS resources and CSI reports provided by higher layers can include a number of hypotheses on SD/PD adaptations. A number of hypotheses on adaptation/configuration of CSI-RS resources can be provided by the serving gNB to the UE 116 via indications for a set of numbers of CSI-RS antenna ports from an indicated CSI-RS resource configuration, a power for CSI-RS transmission, or a power for PDSCH transmission relative to a power for CSI-RS transmission. The CSI report configurations provided by higher layers can also include an UL resource, such as a PUCCH resource, for transmitting a PUCCH providing CSI reports, for example, via PUCCH-CSI-ResourceList if CSI report is provided by PUCCH or via reportSlotConfig and reportSlotOffsetList if CSI reports are provided by PUSCH. The UE 116 is also provided from the serving gNB by higher layers a CSS set or a USS set for detection of the DCI format. DCI providing a CSI report early indication (CEI) can be UE-specific, UE-group-specific, or cell-specific. The search space set configuration can be provided to the UE 116 as a part of PDCCH-Config, PDCCH-ConfigCommon, or DownlinkConfigCommonSIB.

In 1620, the UE 116 monitors PDCCH for detection of the DCI format triggering CSI-RS measurement and CSI report. For a UE-specific DCI format, an existing DCI format, such as DCI format 0_1, can be used or a new DCI format can be defined. For a UE-group-specific DCI format, as one example, K blocks of information can be included in the DCI format for a group of K UEs, where each UE is provided a starting position for its own block via higher layer signaling. Each block can include a field indicating whether CSI-RS measurement and CSI report are triggered for the corresponding UE. Each block can also include a field indicating one or multiple indexes to hypotheses on SD/PD adaptation, such as configurations of CSI-RS resources/CSI reports, for the corresponding UE from the set of configurations provided by higher layers. For CSI reporting on PUSCH, each block may also include a field indicating report slot offset by providing an index from the reportSlotOffsetList provided to the UE 116 by higher layers.

In 1630, the UE 116 measures CSI-RS and provides a CSI report to the serving gNB, if the UE 116 detects the DCI format triggering CSI-RS measurement and CSI report. Otherwise, the UE 116 skips CSI-RS measurement and CSI reporting.

With reference to FIG. 16, an example procedure for a UE to periodically monitor DCI triggering CSI measurement and report, and send CSI report is shown.

FIG. 17 illustrates a diagram of UE sub-grouping 1700 for triggering CSI measurement and report according to embodiments of the present disclosure. For example, UE sub-grouping 1700 can be implemented by the gNB 102 and UEs 111-116 in network 100 of FIG. 1. This example is for illustration only and other embodiments can be used without departing from the scope of the present disclosure.

As another example of UE-group-specific DCI format, N blocks of information can be included in the DCI format for N number of UE groups, where each UE is indicated its group index from the serving gNB by higher layers. Each block can include a field indicating whether CSI-RS measurement and CSI report are triggered for the corresponding group of UEs. Each block can also include a field indicating one or multiple indexes to hypotheses on SD/PD adaptation, such as configurations of CSI resources/CSI report, for the corresponding group of UEs from the set of configurations provided by higher layers.

The procedure for performing a CSI-RS measurement and providing a corresponding CSI report includes a serving gNB indicating to a UE PDCCH monitoring occasions for detection of a DCI format triggering CSI-RS measurement and CSI reporting, and corresponding configurations of CSI-RS resources for measurement and CSI reports, including an UL resource, such as PUCCH resource, for transmitting a PUCCH with the CSI reports. The signaling for the indication can be UE-specific, UE-group-specific, or cell-specific such as by a SIB. For example, a UE can monitor PDCCH to detect a DCI format providing an indication for CSI-RS measurement and CSI reporting according to a CSS set (UE-group-specific) or a USS set (UE-specific). A UE can be indicated or specified to monitor PDCCH for detection of a DCI format providing the indication regardless of the UE's connected mode DRX (C-DRX) state, i.e., the UE 116 can monitor the PDCCH even when the UE 116 is in a C-DRX off-duration. The configurations for the CSI-RS resources and CSI reports that the UE 116 follows can include a number of hypotheses on spatial and power domain adaptations/configurations. A number of hypotheses on adaptations/configurations can be provided by the serving gNB to the UE 116 by higher layers via indication of a set of CSI-RS antenna ports from an indicated configuration of CSI-RS resources, a power for CSI-RS transmission, or a power for PDSCH transmission relative to a power for CSI-RS transmission.

A UE receives an indication by DCI in a PDCCH reception to perform CSI-RS measurements and CSI reporting according to configurations provided by higher layers. If the UE 116 does not receive an indication by DCI, the UE 116 skips CSI-RS measurement and CSI reporting. If the PDCCH monitoring occasion is within the UE's C-DRX off-duration and if the UE 116 does not receive DCI, the UE 116 goes back to sleep mode.

As an example, with reference to FIG. 17, the network 130 can define a set of UEs along a certain beam direction as one UE group. As another example, the network 130 can define a set of UEs in a certain range from the serving gNB as one UE group. With UE grouping, the serving gNB can acquire more detailed/specific information in making decisions on adapting SD/PD parameters along a certain beam direction or in a certain cell coverage range as needed.

The UE 116 starts monitoring PDCCH for detection of the DCI format according to the number of corresponding search space sets. The UE 116 can monitor the PDCCH regardless of the UE's C-DRX state, i.e., even if the UE 116 is in C-DRX off-duration. Also, a PDCCH monitoring timing can be informed to the UE 116 from the serving gNB by higher layers in terms of ‘frame offset’, which is in number of frames from the start of a reference frame to a certain timing indicated in system frame number (SFN), and ‘monitoring occasion’, which indicates the first PDCCH monitoring occasion for the corresponding DCI format.

It is generally beneficial that a size of a DCI format providing CEI is small because a corresponding decoding reliability needs to be large. UEs that fail to detect a DCI format providing CEI would not send CSI report as requested by the serving gNB that can result to poor decision making in adapting SD/PD network operation parameters.

If UE-group specific or cell-specific DCI format is used to provide CEI, it needs to be received by a number of UEs within the serving cell. Therefore, it is appropriate for PDCCH monitoring for detection of the DCI format providing CEI to be according to one or more CSS sets and for a CRC of the DCI format to be scrambled by a dedicated RNTI such as a NW energy saving RNTI (NES-RNTI). The size of the DCI format providing CEI can be different, possibly smaller, than the sizes of other DCI formats that UEs can be configured to monitor according to CSS sets, such as for example a DCI format 2_0 used for indicating slot format to a group of UEs. Therefore, a UE design constraint for maintaining a “3+1” limit for sizes of DCI formats that the UE 116 can decode from PDCCH receptions per cell needs to be addressed when the UE 116 also decodes DCI format providing CEI for PDCCH receptions on a cell.

In a first approach, a size of DCI format providing CEI can be different from sizes of other DCI formats that a UE monitors corresponding PDCCHs on a same cell. Then, in order to maintain a “3+1” limit for sizes of DCI formats for the cell, a UE may need to perform additional size matching for DCI formats the UE 116 receives corresponding PDCCHs for the cell where the UE 116 receives PDCCHs that provide DCI format for providing CEI. That would lead to increased size for some of the DCI formats as size matching between two DCI formats is by padding zeroes to one of the DCI formats that has smaller size.

In a second approach, to avoid a potential increase for sizes of other DCI formats, a size of the DCI format providing CEI can be defined by the specifications of the system operation to be same as a size of an existing DCI format such as DCI format 0_0 or 1_0. The DCI format sending CEI can be provided by PDCCH receptions according to CSS sets in the active DL BWP of a UE, or in the initial DL BWP if PDCCH receptions for the corresponding DCI format are only in the initial DL BWP. For example, DCI format 1_0 can be used to schedule PDSCH providing SIBs, or random-access response, or paging, or, when the CRC is scrambled by a C-RNTI, schedule UE-specific PDSCH. For a typical DCI format 1_0 size of about 40 bits, excluding CRC, a serving gNB can indicate a size of the fields. If the total size of the DCI format providing CEI is smaller than the size of DCI format 1_0, the UE 116 can pad bits to the DCI format providing CEI, such as bits with value of 0, until a size of the DCI format providing CEI is same as a size of DCI format 1_0 provided by PDCCHs that the UE 116 monitors according to CSS sets.

In a third approach, instead of being specified to be the same as the size of DCI format 1_0 provided by PDCCHs that a UE monitors according to CSS sets, a size of the DCI format providing CEI can be separately indicated to a UE by a serving gNB through higher layer signaling, such as through a SIB or through UE-specific RRC signaling. The third approach provides flexibility to a serving gNB compared to the second approach at the expense of marginal signaling overhead. For example, if sizes of other DCI formats that a UE monitors corresponding PDCCHs according to CSS sets are smaller than a size of DCI format 1_0 that the UE 116 monitors corresponding PDCCHs according to CSS sets, the serving gNB can indicate one of the sizes of the other DCI formats. For example, if search space sets indicated to UE by the serving gNB are such that associated sizes of DCI formats are less than the “3+1” limit, the DCI format providing CEI can have any size without requiring size matching for the other DCI formats. The indication of the size of the DCI format providing CEI can be optional. If provided, a UE appends zeroes to the bits of the fields in the DCI format providing CEI until a size is same as the indicated size. If not provided, a UE determines a size of the DCI format providing CEI based on a total number of bits for the fields of the DCI format.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user equipment (UE) to report channel state information (CSI) including one or more sub-reports, the method comprising:
receiving:
first information related to reception of one or more non-zero power CSI reference signals (NZP CSI-RSs) on a cell,
second information related to a first number of sub-configurations corresponding to respective CSI sub-reports, wherein each sub-configuration corresponds to an adaptation of parameters in one or more of a spatial or power domain associated with receptions of channels or signals,
third information related to indicating a second number of sub-configurations from the first number of sub-configurations, the second number of sub-configurations corresponding to a second number of CSI sub-reports, respectively,
fourth information related to a physical uplink control channel (PUCCH) or a physical uplink shared channel (PUSCH) for transmitting the CSI report, and
the one or more NZP CSI-RSs based on the first information;
determining the second number of CSI sub-reports based on the second information, the third information, and the reception of the one or more NZP CSI-RSs; and
transmitting the PUSCH with the CSI report including the second number of CSI sub-reports.

2. The method of claim 1, wherein:
the second information provides an NZP CSI-RS antenna port subset via a bit sequence of a size equal to a number of antenna ports of the one or more NZP CSI-RSs indicated by the first information,
a bit value ‘0’ indicates that a corresponding antenna port is disabled, and
a bit value ‘1’ indicates that a corresponding antenna port is enabled.

3. The method of claim 1, wherein:
the second information provides mixed CSI codebook combination in a slot for the first number of sub-configurations,
typeI-SinglePanel codebook is indicated for a first sub-configuration, and
typeI-MultiPanel codebook is indicated for a second sub-configuration.

4. The method of claim 1, wherein:
the second information provides a rank indicator (RI) restriction indicator, and
the RI restriction indicator is provided by:
parameter n1-n2, when a sub-configuration is associated with a typeI-SinglePanel codebook, and
parameter ng-n1-n2, when a sub-configuration is associated with a typeI-MultiPanel codebook.

5. The method of claim 1, wherein the third information is provided by:
a radio resource control (RRC) message indicating a list of trigger states, wherein each trigger state from the list of trigger states indicates one or more sub-configuration indexes from the first number of sub-configurations, and
a DCI format indicating an index from the list of trigger states.

6. The method of claim 1, wherein the third information is provided by a medium access control control element (MAC CE) for activating or deactivating semi-persistent CSI reporting on PUCCH by indicating activation or deactivation of a corresponding sub-configuration from the first number of sub-configurations.

7. The method of claim 1, further comprising:
receiving:
information related to a search space set for receiving physical downlink control channels (PDCCHs) in connected mode discontinuous reception (C-DRX) off-durations, wherein a PDCCH from the PDCCHs provides a DCI format indicating a CSI report early indication (CEI), and
the PDCCH,
wherein the CEI being positive indicates to receive the one or more NZP CSI-RSs based on the first information, determine the second number of CSI sub-reports, and transmit the PUCCH or the PUSCH with the CSI report including the second number of CSI sub-reports.

8. A user equipment (UE), comprising:
a transceiver configured to receive:
first information related to reception of one or more non-zero power channel state information reference signals (NZP CSI-RSs) on a cell,
second information related to a first number of sub-configurations corresponding to respective channel state information (CSI) sub-reports, wherein each sub-configuration corresponds to an adaptation of parameters in one or more of a spatial or power domain associated with receptions of channels or signals,
third information related to indicating a second number of sub-configurations from the first number of sub-configurations, the second number of sub-configurations corresponding to a second number of CSI sub-reports, respectively,
fourth information related to a physical uplink control channel (PUCCH) or a physical uplink shared channel (PUSCH) for transmitting the CSI report, and
the one or more NZP CSI-RSs based on the first information; and
a processor operably coupled to the transceiver, the processor configured to determine the second number of CSI sub-reports based on the second information, the third information, and the reception of the one or more NZP CSI-RSs,
wherein the transceiver is further configured to transmit the PUSCH with the CSI report including the second number of CSI sub-reports.

9. The UE of claim 8, wherein:
the second information provides an NZP CSI-RS antenna port subset via a bit sequence of a size equal to a number of antenna ports of the one or more NZP CSI-RSs indicated by the first information,
a bit value ‘0’ indicates that a corresponding antenna port is disabled, and
a bit value ‘1’ indicates that a corresponding antenna port is enabled.

10. The UE of claim 8, wherein:
the second information provides mixed CSI codebook combination in a slot for the first number of sub-configurations,
typeI-SinglePanel codebook is indicated for a first sub-configuration, and
typeI-MultiPanel codebook is indicated for a second sub-configuration.

11. The UE of claim 8, wherein:
the second information provides a rank indicator (RI) restriction indicator, and
the RI restriction indicator is provided by:
parameter n1-n2, when a sub-configuration is associated with a typeI-SinglePanel codebook, and
parameter ng-n1-n2, when a sub-configuration is associated with a type1-MultiPanel codebook.

12. The UE of claim 8, wherein the third information is provided by:
a radio resource control (RRC) message indicating a list of trigger states, wherein each trigger state from the list of trigger states indicates one or more sub-configuration indexes from the first number of sub-configurations, and
a DCI format indicating an index from the list of trigger states.

13. The UE of claim 8, wherein the third information is provided by a medium access control control element (MAC CE) for activating or deactivating semi-persistent CSI reporting on PUCCH by indicating activation or deactivation of a corresponding sub-configuration from the first number of sub-configurations.

14. The UE of claim 8, wherein:
the transceiver is further configured to receive:
information related to a search space set for receiving physical downlink control channels (PDCCHs) in connected mode discontinuous reception (C-DRX) off-durations, wherein a PDCCH from the PDCCHs provides a DCI format indicating a CSI report early indication (CEI), and
the PDCCH; and
the CEI being positive indicates to receive the one or more NZP CSI-RSs based on the first information, determine the second number of CSI sub-reports, and transmit the PUSCH with the CSI report including the second number of CSI sub-reports.

15. A base station (BS), comprising:
a processor; and
a transceiver operably coupled to the processor, the transceiver configured to:
transmit:
first information related to transmission of one or more non-zero power channel state information reference signals (NZP CSI-RSs) on a cell,
second information related to a first number of sub-configurations corresponding to respective channel state information (CSI) sub-reports, wherein each sub-configuration corresponds to an adaptation of parameters in one or more of a spatial or power domain associated with transmissions of channels or signals,
third information related to indicating a second number of sub-configurations from the first number of sub-configurations, the second number of sub-configurations corresponding to a second number of CSI sub-reports, respectively,
fourth information related to a physical uplink control channel (PUCCH) or a physical uplink shared channel (PUSCH) for the CSI report, and
the one or more NZP CSI-RSs based on the first information; and
receive the PUSCH with the CSI report including the second number of CSI sub-reports.

16. The BS of claim 15, wherein:
the second information provides an NZP CSI-RS antenna port subset via a bit sequence of a size equal to a number of antenna ports of the one or more NZP CSI-RSs indicated by the first information,
a bit value ‘0’ indicates that a corresponding antenna port is disabled, and
a bit value ‘1’ indicates that a corresponding antenna port is enabled.

17. The BS of claim 15, wherein:
the second information provides mixed CSI codebook combination in a slot for the first number of sub-configurations,
typeI-SinglePanel codebook is indicated for a first sub-configuration, and
typeI-MultiPanel codebook is indicated for a second sub-configuration.

18. The BS of claim 15, wherein:
the second information provides a rank indicator (RI) restriction indicator, and
the RI restriction indicator is provided by:
parameter n1-n2, when a sub-configuration is associated with a type1-SinglePanel codebook, and
parameter ng-n1-n2, when a sub-configuration is associated with a type1-MultiPanel codebook.

19. The BS of claim 15, wherein the third information is provided by:
a radio resource control (RRC) message indicating a list of trigger states, wherein each trigger state from the list of trigger states indicates one or more sub-configuration indexes from the first number of sub-configurations, and
a DCI format indicating an index from the list of trigger states.

20. The BS of claim 15, wherein the third information is provided by a medium access control control element (MAC CE) for activating or deactivating semi-persistent CSI reporting on PUCCH by indicating activation or deactivation of a corresponding sub-configuration from the first number of sub-configurations.
